(19) United States
(12) Patent Application Publication
(10) Pub. No.: US 2024/0222680 A1
(43) Pub. Date: Jul. 4, 2024

(54) BATTERY MANUFACTURING APPARATUS AND METHODS

(71) Applicant: Rivian IP Holdings, LLC, Plymouth, MI (US)

(72) Inventors: Terri Chai Lin, Fremont, CA (US); Chao Ken Hsu, Fremont, CA (US); Karthik Shankar Bhatt, San Jose, CA (US); Joowook Lee, Palo Alto, CA (US); Bharat Kathpalia, San Francisco, CA (US)

(21) Appl. No.: 18/147,508

(22) Filed: Dec. 28, 2022

(51) Int. Cl. H01M 10/04; H01M 50/46

(52) U.S. Cl. CPC H01M 10/0404; H01M 50/46

(57) ABSTRACT

An apparatus for manufacturing a battery is disclosed. The apparatus can be a holder. The holder can include a first member to support a first side of an electrode stack. The electrode stack can include a solid-state electrolyte layer and an electrode layer. The holder can include a second member to support a second side of the electrode stack. At least one of the first member and the second member can apply a pressure to the electrode stack to maintain alignment of the solid-state electrolyte layer and the electrode layer.

### INTRODUCTION

Vehicles can use electric power to power a motor. Electric power can be provided by a battery to power the vehicle or components thereof.

### SUMMARY

An apparatus for manufacturing a battery can be or include an apparatus. The apparatus can be a holder to maintain alignment of an electrode stack (e.g., a stack of at least one electrode layer and at least one solid-state electrolyte layer). The holder can include a first member to support a first side of the electrode stack and a second member to support a second side of the electrode stack. The first member or the second member can apply a pressure to the electrode stack with the first side of the electrode stack supported by the first member and the second side of the electrode stack supported by the second member. For example, the first member can be coupled with the second member, such as via a clamping mechanism, to apply the pressure to the electrode stack. The pressure can maintain alignment of the electrode layer and the solid-state electrolyte layer with the electrode stack positioned within the holder (e.g., between the first member and the second member).

At least one aspect is directed to an apparatus. The apparatus can be a holder. The holder can include a first member to support a first side of an electrode stack. The electrode stack can include a solid-state electrolyte layer and an electrode layer. The holder can include a second member to support a second side of the electrode stack. At least one of the first member and the second member can apply a pressure to the electrode stack to maintain alignment of the solid-state electrolyte layer and the electrode layer.

At least one aspect is directed to a method. The method can be a method of manufacturing a battery cell. The method can include supporting a first side of an electrode stack with a first member of a holder. The electrode stack can include a solid-state electrolyte layer and an electrode layer. The method can include providing a second member of the holder on a second side of the electrode stack. The method can include applying, via at least one of the first member or the second member, a pressure to the electrode stack to maintain alignment of the solid-state electrolyte layer and the electrode layer.

At least one aspect is directed to a battery cell. The battery cell can include an aligned electrode stack made from an electrode stack. The electrode stack can include a solid-state electrolyte layer and an electrode layer. A first side of the electrode stack can be supported by a first member of a holder. A second member of the holder can be provided on a second side of the electrode layer stack. A pressure can be applied via at least one of the first member or the second member to the electrode layer stack to maintain alignment of the solid-state electrolyte layer and the electrode layer.

At least one aspect is directed to a method of providing an apparatus. The apparatus can be a holder. The holder can include a first member to support a first side of an electrode stack. The electrode stack can include a solid-state electrolyte layer and an electrode layer. The holder can include a second member to support a second side of the electrode stack. At least one of the first member and the second member can apply a pressure to the electrode stack to maintain alignment of the solid-state electrolyte layer and the electrode layer.

At least one aspect is directed to a method of providing a battery cell. The battery cell can include an aligned electrode stack made from an electrode stack. The electrode stack can include a solid-state electrolyte layer and an electrode layer. A first side of the electrode stack can be supported by a first member of a holder. A second member of the holder can be provided on a second side of the electrode layer stack. A pressure can be applied via at least one of the first member or the second member to the electrode layer stack to maintain alignment of the solid-state electrolyte layer and the electrode layer.

These and other aspects and implementations are discussed in detail herein. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example electrode stack, in accordance with some aspects.

FIG. 2 is a flow diagram of an example process of manufacturing a battery cell, in accordance with some aspects.

FIG. 3 is a flow diagram of an example process of manufacturing a battery cell, in accordance with some aspects.

FIG. 4 depicts an example holder for an electrode stack, in accordance with some aspects.

FIG. 5 depicts an example holder for an electrode stack, in accordance with some aspects.

FIG. 6 depicts an example holder for an electrode stack, in accordance with some aspects.

FIG. 7 depicts an example holder for an electrode stack, in accordance with some aspects.

FIG. 8 depicts an example holder for an electrode stack, in accordance with some aspects.

FIG. 9 depicts an example holder for an electrode stack, in accordance with some aspects.

FIG. 10 depicts an example holder for an electrode stack, in accordance with some aspects.

FIG. 11 depicts an example holder for an electrode stack, in accordance with some aspects.

FIG. 12 is a flow diagram of an example method for manufacturing a battery cell, in accordance with some aspects.

FIG. 13 depicts an example electric vehicle, in accordance with some aspects.

FIG. 14 depicts an example battery pack, in accordance with some aspects.

FIG. 15 depicts an example battery module, in accordance with some aspects.

FIG. 16 depicts an example cross sectional view of a battery cell, in accordance with some aspects.

FIG. 17 depicts an example cross sectional view of a battery cell, in accordance with some aspects.

FIG. 18 depicts an example method of providing a holder for an electrode stack, in accordance with some aspects.

FIG. 19 depicts an example method providing a battery cell, in accordance with some aspects.

### DETAILED DESCRIPTION

Following below are more detailed descriptions of various concepts related to, and implementations of, methods, apparatuses, and systems of battery cell manufacturing, such as battery cells including at least one solid-state electrolyte layer. The various concepts introduced above and discussed in greater detail below may be implemented in any of numerous ways.

The present disclosure is directed to systems and methods for handling a solid-state lithium-ion battery electrode stack (e.g., an electrode layer stack). The system or apparatus can include a holder (e.g., housing, container, jig, vehicle) to hold (e.g., support, retain, envelope, keep) the electrode stack. A first side of the electrode stack can be placed directly on a first member of the holder. For example, the first member can define a cavity and the first member can support the electrode stack with the electrode stack positioned within the cavity. The first member can define a support surface on which the electrode stack is placed. At least one solid-state electrolyte layer and at least one electrode layer can be stacked on the first member to create the electrode stack. For example, individual electrolyte layers or electrode layers can be stacked on top of each other to form the electrode stack (e.g., alternating between an electrolyte layer, a first electrode layer, an electrolyte layer, and a second electrode layer) on the first member (e.g., against the first member or within the cavity of the first member). The holder can include a second member. For example, a second side of the electrode stack (e.g., a top side) can be supported by the second member. The second member can be placed on the second side of the electrode stack with the first side of the electrode stack supported by the first member. For example, the electrode stack can be positioned between the first member and the second member.

The first member or the second member of the holder can apply a pressure to the electrode stack. For example, the first member or the second member can apply a pressure to the electrode stack to maintain an alignment between the solid-state electrolyte layer and the electrode layer. Proper alignment between the solid-state electrolyte layer and the electrode layer can prevent electrical shorts between electrode layers, for example. The first member or the second member of the holder can apply a pressure to the electrode stack to maintain an alignment of the solid-state electrolyte layer with the electrode layer as the electrode layer stack is moved from a first position (e.g., a stacking location) to a second position (e.g., a heat pressing position). For example, the electrode stack can be moved from a first position to a second position with the electrode stack within the holder (e.g., between the first member and the second member) and with the first member or the second member applying a pressure to the electrode stack to maintain alignment of the solid-state electrolyte layer with the electrode layer. The housing can enclose all sides of the electrode or certain faces of the jelly roll (e.g., fewer than all sides). For example, the electrode stack can be within a cavity defined by at least one of the first member, the second member, or some other member (e.g., a separate third member) to at least partially enclose the electrode stack within the holder. A clamping mechanism can be coupled with at least one of the first member or the second member to apply pressure to the electrode stack. For example, the clamping mechanism can apply a clamping pressure to the first member or the second member to apply a pressure to the electrode stack with the electrode stack between the first member and the second member. The clamping mechanism can include at least one magnet, at least one mechanical locking mechanism, at least one clamp, at least one clasp, at least one robotic manipulator, at least one clutch, at least one buckle, at least one strap, at least one fastener, or some other mechanism to apply the clamping pressure to the first member or the second member.

The electrode stack can be moved from a first position to a second position within the holder. The electrode stack can be removed from the holder for further processing with the electrode stack in the second position. For example, the second member can be removed from the second side of the electrode stack such that the electrode stack is accessible (e.g., exposed) and such that the electrode stack can be retrieved (e.g., grabbed, lifted, grasped, moved) by at least one actuator (e.g., a mandrel, a pick-and-place robotic arm, or some other actuator). The actuator can remove the electrode stack from the first member and provide the electrode stack to another operation (e.g., a heat press operation or some other operation). The electrode stack can be processed with the electrode stack positioned within the holder. For example, an actuator can move the electrode stack to a heat press operation with the electrode stack positioned between the first member and the second member of the holder, where the electrode stack can be pressed or heated as the holder maintains alignment of the electrode stack. The holder can be or include a thermally insulative material to retain heat between the first member and the second member to facilitate a heat press operation. For example, the electrode stack can be positioned within a cavity of the holder or enclosed by the holder, where the holder retains heat to within the cavity or between the first member and the second member.

The disclosed technical solution has the advantage of maintaining an alignment of an electrolyte layer of an electrode stack during processing. For example, the holder described herein can maintain an alignment of multiple electrolyte layers (e.g., solid-state electrolyte layers) with adjacent electrode layers (e.g., anode layers or cathode layers) or with adjacent electrolyte layers. The holder can maintain alignment of a large number (e.g., one hundred or more) electrolyte layers with correspondingly large number of electrode layers. For example, the holder can maintain alignment of a large number of electrolyte layers with a large number of electrode layers such that a battery cell can be produced with a large number of electrode layers and can correspondingly include beneficial or desirable electrical properties (e.g., increased capacity, increased voltage, or some other electrical property). The holder can facilitate the pressing of the electrode stack at an increased pressure or a decreased temperature with the electrolyte layer aligned with an electrode layer or another electrolyte layer. The holder can facilitate the pressing of the electrode stack at a temperature of less than 20 degrees Celsius, 20 degrees Celsius, 20-150 degrees Celsius, greater than 150 degrees Celsius, a room temperature or ambient temperature, or some other temperature. For example, the holder can facilitate the pressing of the electrode stack at a relatively low temperature compared to other pressing methods or systems.

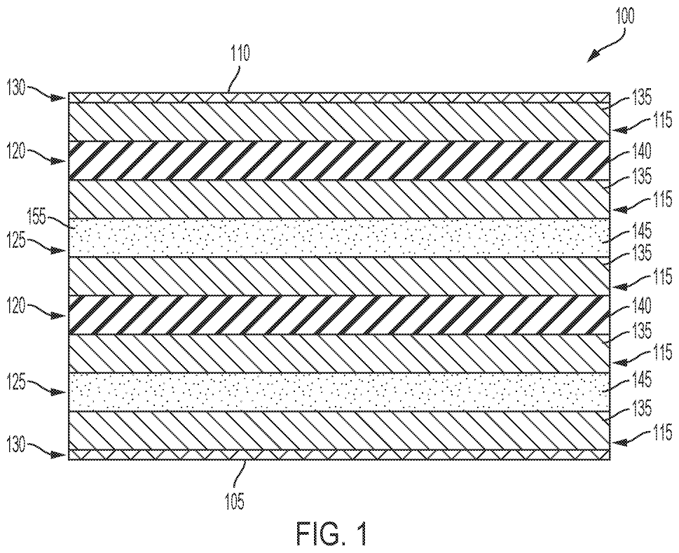

FIG. 1, among others, depicts an electrode stack 100. The electrode stack 100 can include at least one electrolyte layer 115, at least one electrode layer, a first side 105, and a second side 110. For example, the electrolyte layer 115 can be a solid-state electrolyte layer 115 or another electrolyte layer 115 that can be wetted with a liquid electrolyte. The electrode layer can be an anode layer 120 or a cathode layer 125. The electrode stack 100 can include multiple electrolyte layers 115, at least one anode layer 120, and at least one cathode layer 125. For example, the electrode stack 100 can include multiple anode layers 120 stacked with multiple cathode layers 125 and multiple electrolyte layers 115. The anode layers 120 can be stacked in alternating fashion with the cathode layers 125. At least one electrolyte layer 115 can be positioned in between each adjacent anode layers 120 and cathode layers 125 such that the anode layer 120 is not stacked against (e.g., directly abutting, touching, contacting) the cathode layer 125.

The electrode stack 100 can include multiple layers. For example, the electrode stack 100 can include multiple electrolyte layers 115, multiple anode layers 120, and multiple cathode layers. The electrode stack 100 can include thirty one electrode layers (e.g., fifteen anode layers 120 or sixteen cathode layers 125) and thirty two electrolyte layers 115, seventy-five electrode layers (e.g., thirty-seven anode layers 120 or thirty-eight cathode layers 125) and seventy-six electrolyte layers 115, one hundred and one electrode layers (e.g., fifty anode layers 120 or fifty-one cathode layers 125) and one hundred and two electrolyte layers 115, less than thirty-one electrode layers and less than thirty-two electrolyte layers 115, thirty-one to fifty electrode layers and thirty-two to fifty-one electrolyte layers 115, fifty to seventy five electrode layers and fifty-one to seventy-six electrolyte layers 115, seventy-five to one hundred and one electrode layers and seventy-six to one hundred and two electrolyte 115 layers, or greater than one hundred and one electrode layers and greater than one hundred and two electrolyte layers 115.

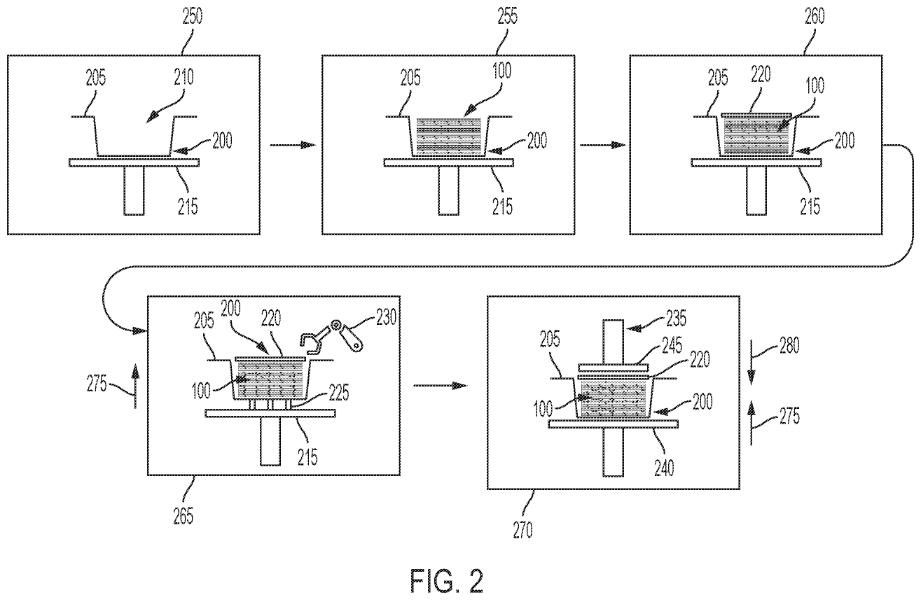

The electrode stack 100 can include an electrolyte layer 115 positioned at the first side 105 or the second side 110 of the electrode stack 100. For example, the first side 105 and the second side 110 of the electrode stack 100 can be two opposing, outermost surfaces of the electrode stack 100, such as a top or a bottom of the electrode stack 100. An electrolyte layer 115 can be or form the first side 105 and the second side 110 of the electrode stack 100 such that neither an anode layer 120 nor a cathode layer 125 are positioned at the first side 105 or the second side 110. The electrode stack 100 can include at least one film 130 positioned at the first side 105 or the second side 110. For example, the film 130 can be or include a film to protect the electrode stack 100, one or more layers of the electrode stack 100 (e.g., the electrolyte layer 115), or an object that contacts the electrode stack 100, such as a holder 200 for an electrode stack 100 as discussed herein, for example, shown in FIGS. 2-11. The film 130 can be or include a material to prevent corrosion of an object in contact with the electrolyte layer 115 of the electrode stack 100. For example, the film 130 can act as a barrier between the electrolyte layer 115 of the electrode stack 100 and a metallic object in contact with the electrolyte layer 115 of the electrode stack 100 to prevent corrosion of the metallic object (e.g., a first member 205 or a second member 220 of a holder 200, as discussed herein). The film 130 can be a disposable film. The film 130 can be a temporary processing film. For example, the film 130 can be used to protect the electrode stack 100 or an object in contact with the electrode stack 100 during processing (e.g., during transportation from one operation to another) and can then be subsequently be removed from the electrode stack 100. The film 130 can be omitted from a battery cell including the electrode stack 100.

The electrode stack 100 can include an alignment of the electrolyte layer 115 with an electrode layer, such as the anode layer 120 or the cathode layer 125. For example, the electrolyte layer 115 can include at least one edge 135. The anode layer 120 can include at least one edge 140. The cathode layer 125 can include at least one edge 145. The alignment of the electrolyte layer 115 with at least one electrode layer can be or include an alignment of the electrolyte layer 115 with the anode layer 120, with the cathode layer 125, or with the anode layer 120 and the cathode layer 125. The alignment of the electrolyte layer 115 with the electrode layer can include at least one edge 135 of the electrolyte layer 115 aligned (e.g., flush, uniform) with at least one edge 140, 145 of the anode layer 120 or the cathode layer 125, respectively. The alignment of the electrolyte layer 115 with the anode layer 120 or the cathode layer 125 can include the edge 135 of the electrolyte layer 115 aligned with both the edge 140 of the anode layer 120 and the edge 145 of the cathode layer 125 such that a side 155 of the electrode stack 100 is flat (e.g., straight, non-jagged, otherwise aligned), as depicted in FIG. 1, among others. The alignment of the electrolyte layer 115 with the electrode layer (e.g., the anode layer 120 or the cathode layer 125) can include at least one edge of the electrolyte layer 115 extending outward from the side 155 of the electrode stack 100 at a distance that differs from a distance at which an edge 140 of the anode layer 120 or an edge 145 of the cathode layer 125 extends from the side 155. For example, the electrolyte layers 115 can extend from the side 155 at a greater distance than the electrode layers to create a jagged side 155 of the electrode stack 100. The alignment of the electrolyte layer 115 with the electrode layer (e.g., the anode layer 120 or the cathode layer 125) can include an alignment of a center point of the electrolyte layer 115 with a center point of the anode layer 120 or the cathode layer 125, respectively. The alignment of the electrolyte layer 115 with the electrode layer can include an alignment of some feature (e.g., an edge, a center point, a center of gravity, or some other feature) with a feature (e.g., an edge, a center point, a center of gravity, or some other feature) one or more of the anode layer 120 or the cathode layer 125.

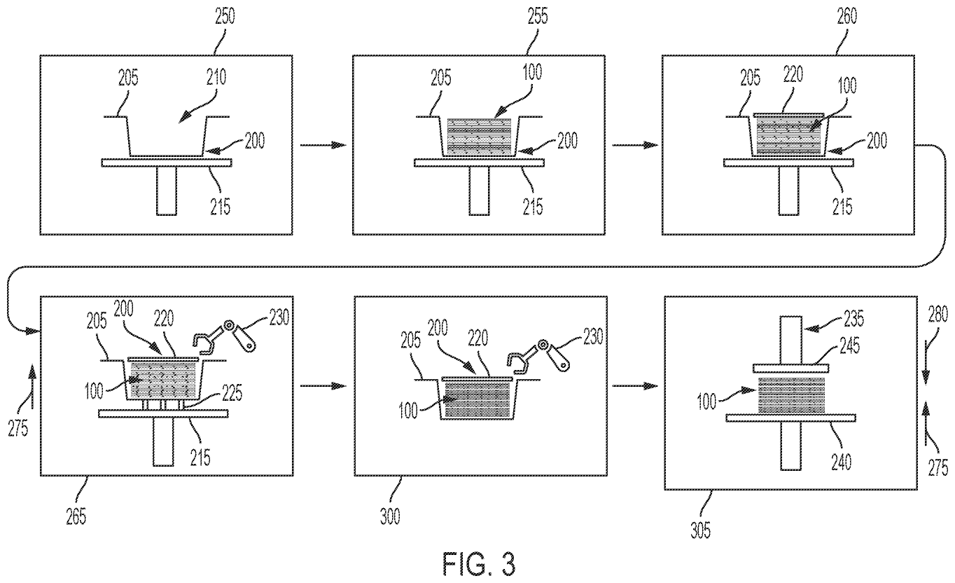

As depicted in FIGS. 2 and 3, among others, a holder 200 can support the electrode stack 100. For example, the holder 200 can include a first member 205 and a second member 220. The holder 200 can support the electrode stack 100. For example, the first member 205 of the holder 200 can support a one side (e.g., the first side 105) of the electrode stack 100 and the second member 220 can support another side (e.g., the second side 110) of the electrode stack 100. The holder 200 can facilitate the movement of the electrode stack from one position to another position during manufacture of a battery cell. For example, the holder 200 can support the electrode stack 100 as the electrode stack 100 is created (e.g., by stacking of individual layer or groups of layers) and as the electrode stack 100 undergoes a heat press operation or some other operation. The holder 200 can support the electrode stack 100 during an inspection operation, such as an x-ray inspection operation or some other inspection operation to verify alignment of the layers of the electrode stack 100. The holder 200 can maintain an alignment of the electrode stack 100 as the electrode stack 100 is moved from one position to another. For example, the first member 205 or the second member 220 can hold the electrode stack 100 in an orientation, such as an orientation where an electrolyte layer 115 is aligned with an electrode layer (e.g., an anode layer 120 or a cathode layer 125) by supporting two or more sides of the electrode stack 100 and preventing or reducing a movement of individual layers of the electrode stack 100 with respect to each other.

The holder 200 can include the first member 205 to support the first side 105 of the electrode stack 100. For example, the electrode stack 100 can be provided to the first member 205 of the holder 200. The first member 205 can be a bottom-most member of the holder 200 in a first orientation where the electrode stack 100 is provided to the first member 205. For example, the electrode stack 100 can be placed on the first member 205 of the holder 200 as a completed stack (e.g., a stack at least one electrolyte layer 115, at least one anode layer 120, and at least one cathode layer 125). The electrode stack 100 can be created on the first member 205. For example, the layers of the electrode stack 100 (e.g., at least one electrolyte layer 115, at least one anode layer 120, at least one cathode layer, or at least one film 130) can be provided to the first member 205 as individual layers, groups of layers (e.g., groups of two or more layers), or in some other manner such that the electrode stack 100 is built upon the first member 205. Layers can be stacked on the first member 205 until the completed electrode stack (e.g., a stack at least one electrolyte layer 115, at least one anode layer 120, and at least one cathode layer 125) results. The first side 105 of the electrode stack 100 can be supported by the first member 205. For example, the first side 105 of the electrode stack 100 can be positioned on (e.g., positioned against, be placed on, touch, abut, rest upon, directly or indirectly contact) the first member 205. The first side 105 of the electrode stack 100 can be the film 130, the electrolyte layer 115, the anode layer 120, or the cathode layer 125. The first side 105 can be positioned directly against the first member 205 such that there is direct contact between the first side 105 and at least one surface of the first member 205. The first side 105 of the electrode stack 100 can be positioned indirectly against the first member 205 such that there is some intervening material (e.g., a film 130 or some other layer) between the first side 105 and a surface of the first member 205.

The holder 200 can include the second member 220 to support the second side 110 of the electrode stack 100. For example, the second member 220 can be a top-most member of the holder 200 with the holder 200 in the first orientation (e.g., the orientation in which the electrode stack 100 is provided to the first member 205). The second member 220 can be provided to the second side 110 of the electrode stack 100. For example, the electrode stack 100 can be positioned on (e.g., stacked on) the first member 205 such that the second side 110 of the electrode stack 100 is exposed (e.g., upward-facing, accessible). The electrode stack 100 can extend away from the first member 205 such that the second side 110 is spaced apart from the first member 205. The second member 220 can be placed on (e.g., against) the second side 110 of the electrode stack 100 such that the second side 110 of the electrode stack 100 can be supported by the second member 220. For example, the second member 220 can support (e.g., contact, touch, abut, be positioned on) the second side 110 of the electrode stack 100 such that the electrode stack 100 is positioned between the first member 205 and the second member 220 of the holder 200. The second side 110 of the electrode stack 100 can be positioned on (e.g., positioned against, be placed on, touch, abut, rest upon, directly or indirectly contact) the second member 220. The second side 110 of the electrode stack 100 can be the film 130, the electrolyte layer 115, the anode layer 120, or the cathode layer 125. The second side 110 can be positioned directly against the second member 220 such that there is direct contact between the second side 110 and at least one surface of the second member 220. The second side 110 of the electrode stack 100 can be positioned indirectly against the second member 220 such that there is some intervening material (e.g., a film 130 or some other layer) between the second side 110 and a surface of the second member 220.

The holder 200 can include the first member 205 or the second member 220 to apply a pressure to the electrode stack 100. For example, the first member 205 or the second member 220 can apply a pressure to the electrode stack 100 to maintain an alignment of the electrolyte layer 115 with an electrode layer (e.g., the anode layer 120 or the cathode layer 125). The first member 205 can support (e.g., contact, touch, abut, be positioned against) the first side 105 of the electrode stack 100 and the second member 220 can support (e.g., contact, touch, abut, be positioned against) the second side 110 of the electrode stack 100 such that the electrode stack 100 is positioned at least partially between the first member 205 and the second member 220 of the holder. Whether by force of gravity or otherwise (e.g., via a clamping pressure or force applied by a clamping mechanism), the first member 205 or the second member 220 can apply a pressure (e.g., a force) to the electrode stack 100 with the electrode stack 100 between the first member 205 and the second member 220. The pressure applied to the electrode stack 100 can be a compressive force to hold the layers of the electrode stack 100 in a position. For example, the pressure can compress the layers of the electrode stack 100 slightly (e.g., a 1-25% reduction in a height of the electrode stack or some other reduction in height) such the layers of the electrode stack 100 are pressed against adjacent layers. The layers of the electrode stack 100 can be pressed against adjacent layers such that an individual layer of the electrode stack 100 cannot move or is substantially prevented from moving (e.g., ±90% reduction in movement) with respect to an adjacent layer or some other layer. For example, an orientation or alignment of the layers of the electrode stack 100 can be substantially preserved (e.g., ±90% preserved) with the pressure applied to the electrode stack 100 to prevent or substantially prevent a movement of the layers of the electrode stack 100. The electrolyte layer 115 of the electrode stack 100 can be stacked in an orientation relative to an adjacent electrode layer (e.g., with an edge 135 of the electrolyte layer 115 aligned (e.g., flush, uniform) with at least one edge 140, 145 of the anode layer 120 or the cathode layer 125, respectively). The pressure applied to the electrode stack 100 can prevent the electrolyte layer 115 from moving with respect to the anode layer 120 or the cathode layer 125 such that the alignment of the electrolyte layer 115 with the electrode layer (e.g., the anode layer 120 or the cathode layer 125) is maintained (e.g., preserved, remains unchanged as the electrode stack 100 is moved). The first member 205 or the second member 220 can apply the pressure to the electrode stack 100 with the electrode stack 100, the first member 205, or the second member 220 at a first temperature. The first temperature can be less than 20 degrees Celsius, 20 degrees Celsius, 20-150 degrees Celsius, greater than 150 degrees Celsius, a room temperature or ambient temperature, or some other temperature. For example, the holder 200 can facilitate the pressing of the electrode stack 100 at a relatively low temperature compared to other pressing methods or systems.

The holder 200 can include the first member 205 or the second member 220 to apply a pressure to the electrode stack 100 to maintain an alignment of multiple electrolyte layers 115 with multiple electrode layers (e.g., multiple anode layers 120 and multiple cathode layers 125). For example, the electrode stack 100 can include 1-101 electrode layers and 2-102 electrolyte layers 115 or more than 101 electrode layers and more than 102 electrolyte layers 115. The holder 200 can include the first member 205 or the second member 220 to apply the pressure to the electrode stack 100 to maintain alignment of each of the 2-102 electrolyte layers 115 with adjacent electrode layers or with the other electrolyte layers 115. For example, the holder 200 can maintain alignment of the electrolyte layers 115 of the electrode stack 100 having a large number (e.g., 102) electrolyte layers 115. Because the holder 200 can maintain alignment of electrolyte layers 115 of electrode stacks 100 with many layers, the holder 200 can facilitate the production of electrode stacks 100 or battery cells including the electrode stack 100 having many electrode layers and therefore having desirable electrical properties (e.g., higher voltage, higher amp-hours, or some other property).

As depicted in FIGS. 2 and 3, among others, the holder 200 can include the first member 205 and the second member 220 to support the electrode stack 100 such that the electrode stack 100 can be moved from a first position to a second position. For example, the holder 200 or the electrode stack 100 can be moved from a first position to a second position, as show in one or more of intervals 250, 255, 260, 265, 270, 300, or 305. The electrode stack 100 can be supported by the holder 200 with the holder 200 and the electrode stack 100 the first member 205 of the holder 200 can be provided to (e.g., placed on, supported by, rest against) a stacking surface 215 at interval 250. The stacking surface 215 can be a platform, a fixture, a table, a workbench, or some other surface. The stacking surface 215 can be associated with a first operation. For example, the stacking surface 215 can be a location at which the electrode stack 100 is created by stacking the electrolyte layer 115 and at least one electrode layer (e.g., the anode layer 120 or the cathode layer 125). The stacking surface 215 can be a flat surface or a substantially flat surface (e.g., ±10° from horizontal). The first member 205 can be provided to the stacking surface 215 with the first member 205 in an orientation. For example, the first member 205 can be provided to the stacking surface 215 with a center point, an edge, or some other feature of the first member 205 aligned with or positioned relative to some feature (e.g., an edge, a visual indicator, a center point, or some other feature) of the stacking surface 215. The first member 205 can be provided to the stacking surface 215 in some other orientation (e.g., in an upwards direction, with a cavity of the first member 205 facing upwards). The first member 205 can be provided to the stacking surface 215 via an actuator, such as a pick-and-place robot, a conveyor system, or some other device to move the first member 205 to the stacking surface 215.

The stacking surface 215 can translate (e.g., move) in a vertical direction (e.g., a direction 275 or a direction 280). For example, the stacking surface 215 can be coupled with at least one actuator 225. The actuator 225 can lift the stacking surface 215 or a portion of the stacking surface 215 in the direction 275 to lift the first member 205, the electrode stack 100, or the second member 220 in the direction 275. For example, the actuator 225 can lift the stacking surface 215 in the direction 275 to facilitate a movement of the holder 200 or electrode stack 100 by making the holder 200 or electrode stack 100 more accessible to (e.g., easier to grasp by) at least one actuator 230 or operator. The actuator 225 can extend from the stacking surface 215 to lift an object off of the stacking surface 215 (e.g., to separate an object from the stacking surface 215. For example, the actuator 225 can lift the first member 205, the electrode stack 100, or the second member 220 in the direction 275 to separate the first member 205, electrode stack 100, or second member 220 from the stacking surface 215. The actuator 225 can separate the first member 205, the electrode stack 100, or the second member 220 from the stacking surface 215 to facilitate a movement of the holder 200 or electrode stack 100 by making the holder 200 or electrode stack 100 more accessible to (e.g., easier to grasp by) an actuator 230 or operator.

The actuator 225 can move the first member 205, the electrode stack 100, or the second member 220 in a downwards direction (e.g., the direction 280) to facilitate a stacking of the electrode stack 100. For example, the actuator 225 can lift the first member 205 from the stacking surface 215 as a first layer or group of layers (e.g., a layer or group of layers forming the first side 105) of the electrode stack 100 is provided to the first member 205. As each layer or group of layer is placed on the first member 205, the actuator 225 can move the first member 205 and the stacked layer(s) in the direction 280 such that the next layer or group of layers can be placed on the stack of layers at a same vertical position (e.g., a same distance from the stacking surface 215. For example, the actuator 225 can index the first member 205 as layers are stacked to form the electrode stack 100. An operator, pick-and-place robot, or other mechanism can place a subsequent layer or group of layers to form the electrode stack 100 with each layer or group of layers placed in an identical or substantially identical (e.g., ±95% identical) position, which can improve an accuracy or precision of the placement of the layer. For example, the actuator 225 can index the first member 205 to improve an accuracy or precision of the alignment of the electrolyte layer 115 with the electrode layer (e.g., the anode layer 120 or the cathode layer 125).

The electrode stack 100 can be provided to the first member 205 at interval 255. For example, the electrolyte layer 115, anode layer 120, cathode layer 125, or film 130 can be provided to the first member 205 such that each of the electrolyte layer 115, anode layer 120, cathode layer 125, and film 130 can be supported by the first member 205. For example, the electrolyte layer 115, anode layer 120, or cathode layer 125, can be provided to the first member 205 with the film 130 positioned between the lowermost layer (e.g., an electrolyte layer 115) and the first member 205 to separate the first member 205 from the lowermost layer. For example, the film 130 can contact (e.g., abut, be placed against, touch) the first member 205 and the lowermost layer can contact (e.g., abut, be placed against, touch) the film 130. The film 130 can prevent the first member 205 from being corroded via contact with the electrolyte layer 115, for example. The electrolyte layer 115, anode layer 120, cathode layer 125, or film 130 can be provided to the first member 205 in some sequence (e.g., as a singulated layer, sheet, or leaf) to create the electrode stack 100. For example, the electrolyte layer 115, anode layer 120, cathode layer 125, or film 130 can be provided to the first member 205 individually. The electrolyte layer 115, anode layer 120, cathode layer 125, or film 130 can be provided to the first member 205 two layers at a time, such as a half-cell including an electrolyte layer 115 joined with (e.g., laminated with, adhered to, otherwise joined with) a cathode layer 125 or an anode layer 120. The electrolyte layer 115, anode layer 120, cathode layer 125, or film 130 can be provided to the first member 205 four layers at a time, such as a monocell including two electrolyte layers 115, an anode layer 120, and a cathode layer 125. The electrolyte layer 115, anode layer 120, or the cathode layer 125, can be provided to the first member 205 to create the electrode stack 100 such that the resultant electrode stack 100 can include the alignment of the electrolyte layer 115 with the anode layer 120 or the cathode layer 125.

The second member 220 of the holder 200 can be provided to the second side 110 of the electrode stack 100 at interval 260. For example, the second member 220 can be provided to the second side 110 of the electrode stack 100 at interval 260 such that the second member 220 is supporting the second side 110. The second member 220 can be provided to the electrode stack 100 after the electrolyte layer 115, anode layer 120, cathode layer 125, or film 130 are provided to the first member 205 to create the electrode stack 100. The second member 220 can be provided to the second side 110 of the electrode stack 100 with the second member 220 in an orientation. For example, the second member 220 can be provided to the electrode stack 100 with a center point, edge, or other feature aligned with a feature (e.g., a center point, edge, cutout, or other feature of the first member 205. The second member 220 can contact (e.g., abut, touch, be positioned directly or indirectly against) the second side 110 of the electrode stack 100 as the second member 220 first within a cavity of the first member or some other member (e.g., a third member) of the holder 200, as is discussed in detail herein.

The second member 220 or the first member 205 can apply a pressure to the electrode stack 100 at interval 260. For example, the first member 205 can contact (e.g., abut, touch, be positioned directly or indirectly against) the first side 105 of the electrode stack 100 with the first side 105 supported by the first member 205. The second member 220 can contact (e.g., abut, touch, be positioned directly or indirectly against) the second side 110 of the electrode stack 100 with the second side 110 supported by the second member 220. For example, a gravitational force or some other applied force, such as a clamping pressure or force applied by a clamping mechanism can be applied to at least one of the first member 205 or the second member 220. That force can apply a pressure (e.g., a force) to the electrode stack 100 with the electrode stack 100 between the first member 205 and the second member 220. The pressure applied to the electrode stack 100 can be a compressive force to hold the layers of the electrode stack 100 in a position. For example, the pressure can compress the layers of the electrode stack 100 slightly (e.g., a 1-25% reduction in a height of the electrode stack or some other reduction in height) such the layers of the electrode stack 100 are pressed against adjacent layers at interval 260 and in subsequent intervals, as discussed herein. The layers of the electrode stack 100 can be pressed against adjacent layers to substantially or entirely prevent an individual layer of the electrode stack 100 from moving (e.g., at least ±90% reduction in movement) with respect to an adjacent layer or some other layer. For example, an orientation or alignment of the layers of the electrode stack 100 can be substantially preserved (e.g., ±90% preserved) with the pressure applied to the electrode stack 100 to prevent or substantially prevent a movement of the layers of the electrode stack 100. The electrolyte layer 115 of the electrode stack 100 can be stacked in an orientation relative to an adjacent electrode layer (e.g., with an edge 135 of the electrolyte layer 115 aligned (e.g., flush, uniform) with at least one edge 140, 145 of the anode layer 120 or the cathode layer 125, respectively). The pressure applied to the electrode stack 100 can prevent the electrolyte layer 115 from moving with respect to the anode layer 120 or the cathode layer 125 such that the alignment of the electrolyte layer 115 with the electrode layer (e.g., the anode layer 120 or the cathode layer 125) is maintained (e.g., preserved, remains unchanged as the electrode stack 100 is moved).

An actuator 230 can move the electrode stack 100 from a first position to a second position at interval 265. For example, the actuator 230 can move the electrode stack 100 from a first position to a second position at interval 265 with the first side 105 of the electrode stack 100 supported by the first member 205 and the second side 110 of the electrode stack 100 supported by the second member 220 of the holder 200. The actuator 230 can move the electrode stack 100 from a first position to a second position at interval 265 with the first member 205 or the second member 220 applying a pressure to the electrode stack 100 to maintain alignment of the electrolyte layer 115 with the anode layer 120 or the cathode layer 125. The first position can be the stacking surface 215. The second position can be a bottom plate 240 of a heat press 235, as depicted at interval 270. The actuator 230 can be or include a mandrel, a robotic pick-and-place actuator, a conveyor device, a vacuum-operated pick-and-place robot, or some other actuator. For example, the actuator 230 can grasp the holder 200 with the electrode stack 100 between the first member 205 and the second member 220 of the holder 200. The actuator 230 can lift the holder 200 and the electrode stack 100 from the first location (e.g., the stacking surface 215) and move the holder 200 and the electrode stack 100 to the second location (e.g., the bottom plate 240 of the heat press 235). The first member 205 and the second member 220 of the holder 200 can support the electrode stack 100 as the actuator 230 moves the holder 200 and the electrode stack 100 from the first position to the second position. For example, the first member 205 and the second member 220 of the holder 200 can support the electrode stack 100 and apply a pressure to the electrode stack 100 to maintain alignment of the electrolyte layer 115 with the anode layer 120 or the cathode layer 125 as the actuator 230 moves the holder 200 and the electrode stack 100 from the first position to the second position. The electrode stack 100 can include the alignment of the electrolyte layer 115 with the cathode layer 125 or the anode layer 120 with the electrode stack 100 in the second position being identical or substantially identical (e.g., ±95% identical) to the alignment of the electrolyte layer 115 with the cathode layer 125 or the anode layer 120 with the electrode stack 100 in the first position.

An orientation of the holder 200 can be changed as the holder 200 or the electrode stack 100 is moved from the first position (e.g., the stacking surface 215) to the second position (e.g., the bottom plate 240 of the heat press 235). For example, the actuator 230 can rotate the holder 200 about an axis extending perpendicularly from the stacking surface 215 or the bottom plate 240 (e.g., a y-axis). The electrode stack 100 can be correspondingly rotated with the holder 200 with the electrode stack 100 supported by the holder 200 (e.g., positioned between the first member 205 and the second member 220). The actuator 230 can invert the holder 200 (e.g., flip the holder) 180° as the actuator 230 moves the holder 200 from the first position to the second position. The actuator 230 can rotate the holder 200 about an axis extending within a plane defined by the stacking surface 215 or the bottom plate 240 (e.g., an x-axis, a z-axis, or some other axis). For example, the holder 200 can be rotated such that the first member 205 is the top-most member of the holder 200 and the second member 220 is a lower-most member of the holder 200. The electrode stack 100 can be correspondingly rotated with the holder 200 such that the first side 105 of the electrode stack 100 is a top-most side and the second side 110 of the electrode stack 100 is a lower-most side. The actuator 230 can change the orientation of the holder 200 and the electrode stack 100 in some other manner as the actuator 230 moves the electrode stack 100 from the first position to the second position.

The heat press can apply a second pressure to the electrode stack 100 with the first member 205 supporting the first side 105 of the electrode stack 100. For example, the heat press 235 can apply the second pressure or heat to the electrode stack 100 at interval 270. As depicted in FIG. 2, among others, the heat press 235 can include a top plate 245 and the bottom plate 240. The heat press 235 can apply the second pressure to the electrode stack 100 with the first member 205, the electrode stack 100, and the second member 220 positioned between the first surface (e.g., the top plate 245) and the second surface (e.g., the bottom plate 240) of the heat press 235. For example, the top plate 245 or the bottom plate 240 can move relative to each other in a direction (e.g., a vertical direction) to apply a pressure to the electrode stack 100 during a heat press operation. For example, the bottom plate 240 can move in an upwards direction 275 towards the top plate 245 to apply a pressure to the holder 200 and the electrode stack 100 with the electrode stack within the holder 200, where the bottom plate 240 acts against (e.g., contacts, presses on) the first member 205 to apply the pressure and the top plate 245 acts against (e.g., contacts, presses on) the second member 220. The top plate 245 can move in a downwards direction 280 towards the bottom plate 240 to apply a pressure to the holder 200 and the electrode stack 100 with the electrode stack 100 within the holder 200, where the top plate 245 acts against (e.g., contacts, presses on) the second member 220 to apply the pressure and the bottom plate 240 acts against (e.g., contacts, presses on) the first member 205 to apply the pressure. For example, the heat press 235 can apply a pressure of approximately (e.g., ±15%) 250 megapascals (MPa), 1-10 MPa, 10-50 MPa, 50-100 MPa, 5-250 MPa, 50-300 MPa, or greater than 300 MPa to the holder 200 with the holder 200 positioned on the bottom plate 240 or the top plate 245 of the heat press. The pressure applied by the heat press 235 can be transferred from the first member 205 or the second member 220 of the holder 200 to the electrode stack 100 that is supported by the first member 205 and the second member 220. For example, the heat press 235 can apply a pressure (e.g., a force) on the electrode stack 100 of approximately (e.g., ±15%) 250 megapascals, less than 250 megapascals, or more than 250 megapascals. The heat press 235 can compress the electrode stack 100 to increase a density of the electrode stack 100, to facilitate a joining (e.g., adhering, laminating, coupling) of two or more of the layers of the electrode stack 100, or otherwise.

As depicted in FIG. 3, among others, the heat press 235 can apply a pressure to the electrode stack 100 at interval 305 with the electrode stack 100 removed from the holder 200. For example, the electrode stack 100 can be removed from the holder 200 at interval 300. The electrode stack 100 can be removed from holder 200 at interval 300 via at least one actuator 230. For example, an actuator 230 can remove the second member 220 from the second side 110 of the electrode stack 100 such that an actuator 230 can access the electrode stack 100 to remove (e.g., grab, lift, retrieve, move) the electrode stack 100 from the first member 205. The actuator 230 can move the electrode stack 100 from the first member 205 with the electrode stack 100 and the holder 200 in a third position (e.g., an intermediate position between the stacking surface 215 and the bottom plate 240 of the heat press 235). The third position can be some position proximate to (e.g., within 1 meter, within 25 centimeters, or at some other distance) from the heat press such that the actuator 230 can retrieve the electrode stack 100 and place the electrode stack 100 in the second position (e.g., the bottom plate 240 of the heat press 235).

The heat press 235 can apply a second pressure to the electrode stack 100 once the electrode stack 100 has been removed from the holder 200 at interval 305. The top plate 245 or the bottom plate 240 can move relative to each other in a direction (e.g., a vertical direction) to apply a pressure to the electrode stack 100 during a heat press operation. For example, the bottom plate 240 can move in an upwards direction 275 towards the top plate 245 to apply a pressure directly the electrode stack 100 (e.g., to an electrolyte layer 115, to a film 130, or to some other layer), where the bottom plate 240 acts against (e.g., contacts, presses on) the first side 105 or the second side 110 of the electrode stack 100 to apply the pressure and the top plate 245 engages with (e.g., acts against, contacts, presses on) the second side 110 or the first side 105 of the electrode stack, respectively. The top plate 245 can move in a downwards direction 280 towards the bottom plate 240 to apply a pressure to the electrode stack 100, where the top plate 245 engages with (e.g., acts against, contacts, presses on) the second side 110 or the first side 105 of the electrode stack 100 to apply the pressure and the bottom plate 240 acts against (e.g., contacts, presses on) the first side 105 or the second side 110 to apply the pressure to the electrode stack 100, respectively. For example, the heat press 235 can apply a pressure of approximately (e.g., ±15%) 250 megapascals, greater than 250 megapascals, or less than 250 megapascals to the electrode stack 100 with the electrode stack 100 positioned on the bottom plate 240 or the top plate 245 of the heat press 235. The heat press 235 can compress the electrode stack 100 to increase a density of the electrode stack 100, to facilitate a joining (e.g., adhering, laminating, coupling) of two or more of the layers of the electrode stack 100, or otherwise.

The heat press 235 can be heated to provide heat to the electrode stack 100 during the heat press operation at interval 270. For example, the heat press 235 can be or include at least one heating element to generate heat to provide heat to the electrode stack 100 as the heat press 235 applies a pressure to the electrode stack 100 or to the holder 200 with the electrode stack 100 within the holder 200. The bottom plate 240 or the top plate 245 of the heat press 235 can be heated to apply heat to the first member 205 or the second member 220 of the holder 200 or to the first side 105 or the second side 110 of the electrode stack 100. For example, the bottom plate 240 can be at an elevated temperature relative to an ambient temperature to apply heat to the first member 205 of the holder 200 or the first side 105 of the electrode stack 100. The top plate 245 can be at an elevated temperature relative to an ambient temperature to apply heat to the second member 220 of the holder 200 or the second side 110 of the electrode stack 100. The heat press 235 can apply heat to the electrode stack 100 to facilitate a joining (e.g., adhering, laminating, coupling) of two or more of the layers of the electrode stack 100 or for some other reason. The holder 200 can retain heat to provide prolonged heat to the electrode stack 100.

The holder 200 can include the first member 205 defining a cavity 210. For example, as depicted in FIGS. 2-4, among others, the first member 205 can include a cavity 210 to receive the electrode stack 100. The cavity 210 can be an impression, indent, void, opening, or aperture extending partially through the first member 205. The cavity 210 can include a cross-sectional dimension, geometry, or shape to receive the electrode stack 100. For example, the cavity 210 can include a size (e.g., a cross-sectional shape) that is sufficiently large to receive at least one layer of the electrode stack 100 (e.g., an electrolyte layer 115, an anode layer 120, a cathode layer 125, a film 130, or some other layer). The cavity 210 can include a depth to receive at least a portion of the electrode stack 100 (e.g., 50% of a height of the electrode stack 100, 90% of the height of the electrode stack 100, or some other proportion). The cavity 210 can include a continuous perimetral wall or a discontinuous perimetral wall. For example, a perimetral wall defining the cavity 210 can be continuous or substantially continuous (e.g., ±98% continuous) such that there are no openings, gaps, or voids within the perimetral wall and such that an object within the cavity 210 is enclosed on at least four sides. The perimetral wall of the cavity 210 can be discontinuous such that at least one gap, slot, opening, or other void exists to expose at least a portion of the object within the cavity on at least one side.

The first side 105, the second side 110, and at least a portion of at least one side 155 of the electrode stack 100 can be enclosed by the holder 200 with the electrode stack 100 positioned at least partially within the cavity 210. For example, the cavity 210 can enclose four sides of an object (e.g., each of the sides 155 of the electrode stack 100), the first member 205 can support the first side 105 to at least partially enclose the first side 105, and the second member 220 can support the second side 110 of the electrode stack 100 to at least partially enclose the second side 110. The electrode stack 100 can be completely or substantially (e.g., ±80%) enclosed with the electrode stack 100 within the cavity 210 and with the first member 205 supporting the first side 105 and the second member 220 supporting the second side 110.

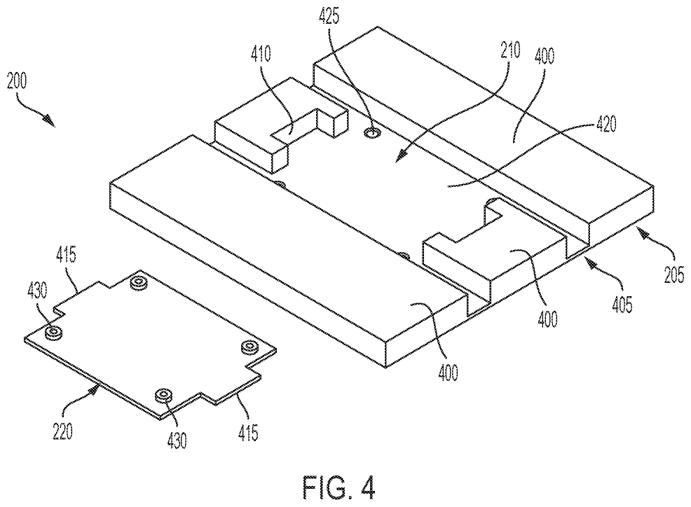

The cavity 210 of the first member 205 can be defined by at least one wall of the first member 205. A depicted in FIG. 4, among others, the first member 205 can include at least one wall 400 and at least one cutout 410. The cutout 410 can at least partially define a boundary of the cavity 210 of the first member 205. For example, one or more cutouts 410 can define a perimeter of the cavity 210. The cavity 210 can have a cross-sectional shape that corresponds to a shape including the cutout 410. The second member 220 can include at least one edge 415. The edge 415 can correspond with (e.g., be sized to fit within) the cutout 410 of the first member 205. For example, the wall 400 of the first member 205 can include the cutout 410 to receive the edge 415 of the second member 220. The second member 220 can fit at least partially within the cavity 210 with the edge 415 of the second member 220 corresponding to the cutout 410. For example, the second member 220 can include at least one edge 415 corresponding to at least one cutout 410 of the first member 205 such that the second member 220 can fit at least partially within the cavity 210 when the second member 220 is provided on the second side 110 of the electrode stack 100 with the first side of the electrode stack 100 supported by the first member 205. The second member 220 can at least partially fit within the cavity 210 with the electrode stack 100 within the cavity 210 (e.g., between the first member 205 and the second member 220). The wall 400 can at least partially surround the cavity 210 to define the cavity 210. For example, the wall 400 can extend from a bottom 420 of the first member 205. The wall 400 can extend perpendicularly or substantially perpendicularly (e.g., ±15°) to the bottom 420 of the first member 205.

The holder 200 can include the first member 205 or the second member 220 including a thermally insulative material to retain heat. For example, the first member 205 of the holder 200 can be or include a thermally insulative material to retain heat within the cavity 210 of the first member 205 with the electrode stack 100 positioned at least partially within the cavity 210. The first side 105, the second side 110, and at least a portion of at least one side 155 of the electrode stack 100 can be enclosed by the holder 200 with the electrode stack 100 positioned at least partially within the cavity 210. For example, the first member 205 can include a wall (e.g., the wall 400 or some other wall) to at least partially enclose the electrode stack 100, where the wall can be or include a thermally insulative material to store heat energy within the wall to provide heat energy to the electrode stack 100 within the cavity 210 for a period of time (e.g., a period of time that is greater than a period of time during which heat would be provided to the electrode stack 100 if the wall of were not present). The first member 205 can receive heat energy from the heat press 235 and store the heat energy within the thermally insulative material of the first member 205 to provide heat to the electrode stack 100. For example, the first member 205 can receive heat energy from the bottom plate 240 or the top plate 245 of the heat press 235 during the heat press operation with the electrode stack 100 positioned between the first member 205 and the second member 220. After the heat press operation concludes (e.g., after the heat press 235 ceases to apply a pressure to the holder 200), the stored heat energy within the first member 205 or the second member 220 can provide heat to the electrode stack 100 between the first member 205 and the second member 220 (e.g., within the cavity 210).

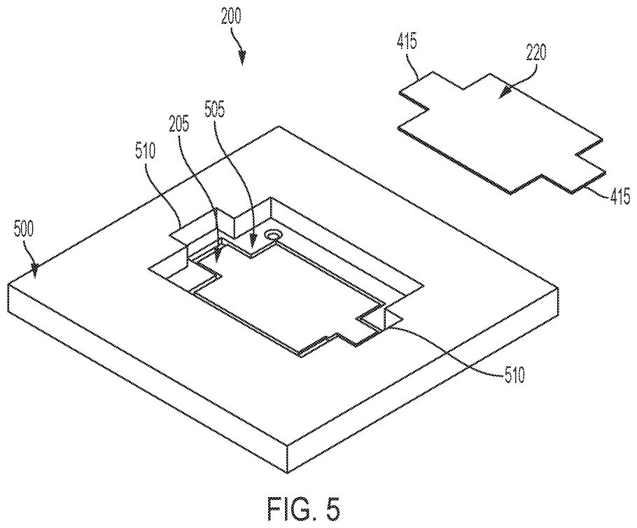

The holder 200 can include at least one third member. For example, as depicted in FIG. 5, among others, the holder 200 can include a third member 500. The third member 500 can define a cavity 505. The cavity 505 of the third member 500 can extend through the third member 500 such that the cavity 505 is open (e.g., accessible) through a first side (e.g., a top) and a second side (e.g., a bottom) of the third member 500. For example, the third member 500 can include at least one cutout 510. The cutout 510 can at least partially define a boundary of the cavity 505 of the third member 500. For example, one or more cutouts 510 can define a perimeter of the cavity 505. The cavity 505 can have a cross-sectional shape that corresponds to a shape including the cutout 510. The first member 205 and the second member 220 can include at least one edge 415. The edge 415 can correspond with (e.g., be sized to fit within) the cutout 510 of the third member 500. For example, the third member 500 can include the cutout 510 to receive the edge 415 of the first member 205 or the second member 220. The first member 205 or the second member 220 can fit at least partially within the cavity 505 with the edge 415 of the first member 205 or the second member 220 corresponding to the cutout 510. For example, the first member 205 or the second member 220 can include at least one edge 415 corresponding to at least one cutout 510 of the third member 500 such that the first member 205 or the second member 220 can respectively fit at least partially within the cavity 505 when the first side 105 of the electrode stack 100 is supported by the first member 205 or when the second member 220 is provided on the second side 110 of the electrode stack 100. The first member 205 or the second member 220 can at least partially fit within the cavity 505 with the electrode stack 100 within the cavity 505 (e.g., between the first member 205 and the second member 220). For example, the first member 205 or the second member 220 can at least partially fit within the cavity 505 with the third member 500 surrounding the electrode stack 100 and with the first side 105 of the electrode stack 100 supported by the first member 205 and the second side 110 of the electrode stack 100 supported by the second member 220.

The holder 200 can include at least one clamping mechanism. For example, the holder 200 can include a clamping mechanism to secure the first member 205 with the second member 220 with the electrode stack 100 between the first member 205 and the second member 220. The clamping member can facilitate an application of pressure to the electrode stack 100. For example, the clamping mechanism can apply a pressure to the electrode stack 100 to maintain alignment of the electrolyte layer 115 with the electrode layer (e.g., the anode layer 120 or the cathode layer 125). The clamping mechanism can couple the first member 205 with the second member 220 such that the first member 205 and the second member 220 are drawn towards each other. For example, the clamping mechanism can apply a force in one or both of the direction 275 or the direction 280 to squeeze the first member 205 towards the second member 220. The force applied by the clamping mechanism can apply a pressure to the electrode stack 100 positioned within the holder 200. For example, the force applied by the clamping mechanism can cause the first member 205 to apply a force to (e.g., against) the first side 105 of the electrode stack 100 and cause the second member 220 to apply a force to (e.g., against) the second side 110 of the electrode stack 100. The pressure (e.g., force) applied to at least one of the first side 105 and the second side 110 of the electrode stack 100 can prevent a layer of the electrode stack 100 from moving with respect to at least one other layer of the electrode stack 100. For example, the force applied by the clamping mechanism can prevent the electrolyte layer 115 from moving with respect to an electrode layer (e.g., an anode layer 120 or a cathode layer 125) to maintain alignment of the electrolyte layer 115 with the electrode layer (e.g., an alignment of an edge 135 of the electrolyte layer 115 with at least one edge 140, 145 of the anode layer 120 or the cathode layer 125, respectively. The clamping mechanism can include at least one magnet, at least one mechanical locking mechanism, at least one clamp, at least one clasp, at least one robotic manipulator, at least one clutch, at least one buckle, at least one strap, at least one fastener, or some other mechanism to apply the clamping pressure to the first member 205 or the second member 220.

As depicted in FIG. 4, among others, clamping mechanism of the holder 200 can be or include at least one first clamping member 425 of the first member 205 and at least one second clamping member 430 of the second member 220. The first clamping member 425 of the first member 205 can correspond with (e.g., interact with, couple with, mate with, fasten to) the second clamping member 430 of the second member 220. For example, the first clamping member 425 can be a fastener and the second clamping member 430 can be a threaded aperture or corresponding fastener (e.g., a nut) to receive the first clamping member 425. An interaction between the first clamping member 425 and the second clamping member 430 can create a clamping force to apply a pressure to the electrode stack 100 with the electrode stack 100 positioned between the first member 205 and the second member 220. For example, the first clamping member 425 can engage the second clamping member 430 to secure the first member 205 to the second member 220, where securing the first member 205 to the second member 220 applies a pressure (e.g., a force) to the first side 105 or the second side 110 of the electrode stack 100). The pressure applied by the first clamping member 425 or the second clamping member 430 can apply a pressure to the electrode stack to maintain an alignment of the electrolyte layer 115 with the electrode layer (e.g., the anode layer 120 or the cathode layer 125) of the electrode stack 100.

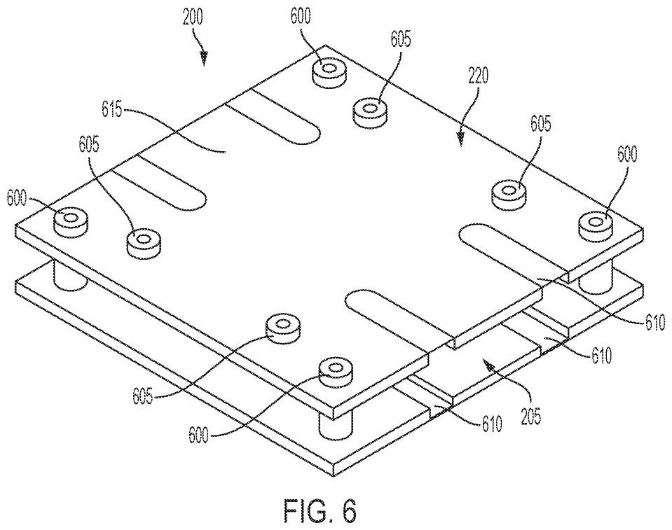

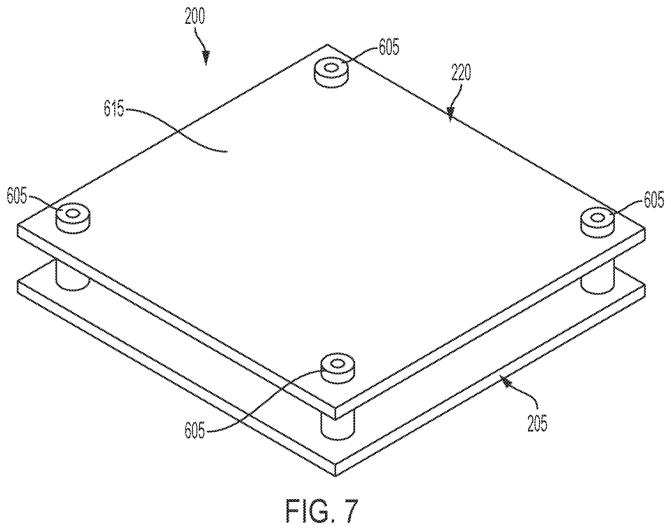

As depicted in FIGS. 6 and 7, among others, the holder 200 can include at least one clamping mechanism 605. The holder 200 can include multiple clamping mechanisms 605 positioned in various locations on the holder 200 to apply an equal or even pressure to the electrode stack 100. For example, as depicted in FIGS. 6 and 7, among others, the holder 200 can include four clamping mechanisms 605, each positioned at or near a corner of the holder 200 to apply an even pressure against the electrode stack 100. The clamping mechanism 605 can be a fastener, a spring-loaded pin, a solid pin, or some other member to facilitate an application of pressure (e.g., a force) to the electrode stack 100. For example, the clamping mechanism 605 can be a spring-loaded pin having at least one spring to apply a force towards the electrode stack 100 with the electrode stack 100 positioned between the first member 205 and the second member 220. For example, the pin can include a spring to apply a spring force in the direction 280 against the second member 220 to cause the second member 220 to apply a force (e.g., a pressure) in the direction 280 against the electrode stack 100. The pin can include a spring to apply a spring force in the direction 275 against the first member 205 to cause the first member 205 to apply a force (e.g., a pressure) in the direction 275 against the electrode stack 100. The clamping mechanism 605 can include at least one fastener. For example, the clamping mechanism can be a fastener to couple the first member 205 with the second member 220, where the fastener can be tightened to increase a pressure (e.g., force) applied by the first member 205 or the second member 220 towards the electrode stack 100.

The clamping mechanism 605 can apply a pressure (e.g., a force) to the electrode stack 100 while still allowing for further compression. For example, the clamping mechanism 605 can allow the second member 220 to move closer to the first member 205 (e.g., to further compress the electrode stack 100) when subject to an external force (e.g., a force other than that applied by the clamping mechanism 605). For example, the holder 200 can receive an external pressure (e.g., force) from the heat press 235 during the heat press operation, where the heat press 235 can cause the first member 205 or the second member 220 to further compress the electrode stack 100 substantially without interference from the clamping mechanism 605. The holder 200 can include multiple clamping mechanisms 605 positioned in various locations on the holder 200 to apply an equal or even pressure to the electrode stack 100. For example, as depicted in FIGS. 6 and 7, among others, the holder 200 can include four clamping mechanisms 605, each positioned at or near a corner of the holder 200 to apply an even pressure against the electrode stack 100. The clamping mechanism 605 can be removable such that the clamping mechanism 605 can be removed from the holder 200. For example, the clamping mechanism 605 or another clamping mechanism can be removed from the holder 200 prior to the heat press operation so as to avoid interfering with or obstructing the top plate 245 or the bottom plate 240 of the heat press 235 during the heat press operation (e.g., to avoid the clamping mechanism 605 itself from being compressed during the heat press operation). The holder 200 can include at least one actuator region 610. The actuator region 610 can be a groove, slot, impression, depression, raised edge, textured portion, or other region of the first member 205 or the second member 220. The actuator 230 can engage with (e.g., contact, grasp, lift, touch) the actuator region 610 can be a region of the first member 205 or the second member 220.

The holder 200 can include a surface to facilitate a heat pressing operation. For example, the holder 200 depicted in FIGS. 6 and 7, among others, can also include a surface 615 to facilitate a heat press operation. The surface 615 can be a flat or substantially flat (e.g., ±20° from horizontal) surface that can receive the top plate 245 or the bottom plate 240 of the heat press 235 during a heat press operation. For example, the top plate 245 or the bottom plate 240 of the heat press 235 can apply a pressure or heat against the surface 615, where the pressure or heat applied to the surface 615 can correspondingly cause the second member 220 or the first member 205 to apply a pressure or heat to the electrode stack 100. The surface 615 can be towards a center of the holder 200. For example, the clamping mechanism 605 or other mechanism (e.g., an alignment mechanism) can be positioned towards an outer edge of the holder 200. The surface 215 can be located away from the clamping mechanism 605 such that the top plate 245 or the bottom plate 240 of the heat press 235 can contact the surface 615 without contacting the clamping mechanism 605.

The holder 200 can include at least one alignment mechanism. The holder 200 can include an alignment mechanism to align the first member 205 with the heat press 235 or with some other object (e.g., the second member 220). For example, the holder 200 can include the alignment mechanism 600 to align the first member 205 with a surface (e.g., the bottom plate 240) of the heat press 235, where the heat press 235 can apply a second pressure to the electrode stack 100 with the first member 205 supporting the first side 105 of the electrode stack 100. As depicted in FIG. 6, among others, the holder 200 can include at least one alignment mechanism 600 in addition to at least one clamping mechanism 605. The alignment mechanism 600 can be a pin, a locator, a slot, a groove, a key or keyway, or some other feature. The alignment mechanism 600 can interact with a corresponding feature on the heat press 235 or other object or surface. For example, the bottom plate 240 of the heat press can include an aperture to receive a pin, a locator, a protrusion to be received in a slot or groove, a keyway or key, or some other feature that can mate with or correspond with the alignment mechanism 600 of the holder 200. The alignment mechanism 600 can engage or interact with a corresponding feature of another object (e.g., the heat press 235) to align the holder 200 relative to the other object. For example, the holder 200 can be aligned with a bottom plate 240 of the heat press 235 with the alignment mechanism 600 engaged with a corresponding feature of the bottom plate 240. The heat press 235 can apply the pressure to the electrode stack 100 via the holder 200 with the holder 200 aligned on the bottom plate 240 of the heat press. For example, the top plate 245 of the heat press 235 can strike the surface 615 of the holder 200 with the alignment mechanism 600 of the holder 200 engaged with the heat press 235 or other object. The alignment mechanism 600 can be removable. For example, the alignment mechanism 600 can be removed prior to a heat press operation—but after aligning the holder 200 with the heat press 235—such that the top plate 245 or the bottom plate 240 of the heat press 235 does not contact the alignment mechanism 600 during the heat press operation.

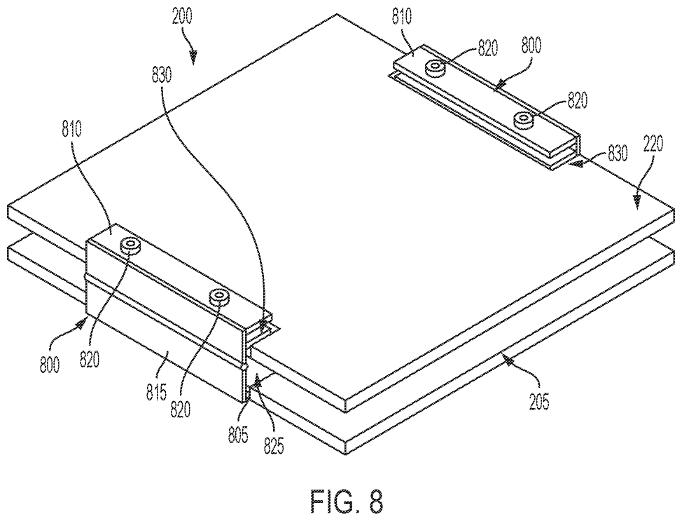

The holder 200 can include a clamping mechanism including a first portion to contact a first region of the first member and a second portion to contact a second region of the second member. For example, a first portion of the clamping mechanism can contact the first member 205 and a second portion of the clamping mechanism can contact the second member 220, where the clamping mechanism can apply a clamping force to the first member and the second member via the first portion and second portion, respectively, to apply a pressure to the electrode stack 100. As depicted in FIG. 8, among others, the holder 200 can include a clamping mechanism 800. The clamping mechanism 800 can include a first portion 805, a second portion 810, and a side portion 815. The first portion 805 and the second portion 810 can extend from the side portion 815. For example, the first portion 805 and the second portion 810 can extend perpendicularly or substantially perpendicularly (e.g., ±30°) from the side portion 815. The first portion 805 of the clamping mechanism 800 can engage with (e.g., contact, interact with, touch, press against) a first region 825 of the first member 205. For example, the first region 825 can be an area, a surface, a recessed portion, or some other part of the first member 205 that can correspond with the first portion 805 of the clamping mechanism 800. The second portion 810 of the clamping mechanism 800 can engage with (e.g., contact, interact with, touch, press against) a second region 830 of the second member 220. For example, the second region 830 can be an area, a surface, a recessed portion, or some other part of the second member 220 that can correspond with the second portion 810 of the clamping mechanism 800. The first portion 805 can interact with the first region 825 and the second portion 810 can interact with the second region 830 with the clamping mechanism coupled with (e.g., secured to) the first member 205 and the second member 220. For example, The first portion 805 can interact with the first region 825 and the second portion 810 can interact with the second region 830 with the first member 205 or the second member 220 applying a pressure to the electrode stack 100 to maintain an alignment of the electrolyte layer 115 with the electrode layer (e.g., the anode layer 120 or the cathode layer 125).

The clamping mechanism 800 can include at least one clamping actuator 820 to apply a clamping force. For example, the clamping mechanism 800 can include the clamping actuator 820 to apply a clamping force via the clamping mechanism 800 to the first member 205 or the second member 220. The clamping actuator 820 can be a fastener, a magnet, a spring-loaded plate, a spring loaded pin, or some other device to apply a force towards the first member 205 or the second member 220 to create a clamping force. For example, the clamping mechanism 800 can include a first clamping actuator 820 associated with the first portion 805 and a second clamping actuator 820 associated with the second portion 810 of the clamping mechanism 800. The first clamping actuator 820 can apply a clamping force (e.g., a pressure) to the first region 825 of the first member 205 in a direction towards the second member 220 (e.g., the direction 275). For example, the first clamping actuator 820 can apply a force to the first member 205 to cause the first member 205 to apply a force to the electrode stack 100 between the first member 205 and the second member 220. The second clamping actuator 820 can apply a clamping force (e.g., a pressure) to the second region 830 of the second member 220 in a direction towards the first member 205 (e.g., the direction 280). For example, the second clamping actuator 820 can apply a force to the second member 220 to cause the second member 220 to apply a force to the electrode stack 100 between the first member 205 and the second member 220.

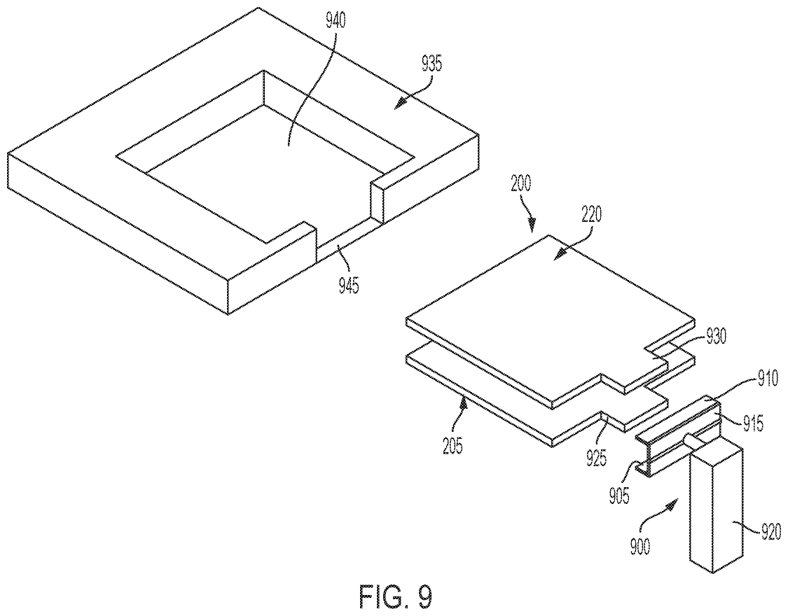

As depicted in FIG. 9, among others, the holder 200 can include a clamping mechanism 900 to secure the first member 205 with the second member 220. The clamping mechanism 900 can include a first portion 905, a second portion 910, a side portion 915, and a grasping portion 920. The first portion 905 and the second portion 910 can extend from the side portion 915. For example, the first portion 905 and the second portion 910 can extend perpendicularly or substantially perpendicularly (e.g., ±30°) from the side portion 915. The first portion 905 of the clamping mechanism 900 can engage with (e.g., contact, interact with, touch, press against) a first region 925 of the first member 205. For example, the first region 925 can be an area, a surface, extension, protrusion, or some other part of the first member 205 that can correspond with the first portion 905 of the clamping mechanism 800. As depicted in FIG. 9, among others, the first region 925 can extend from the first member 205. The second portion 910 of the clamping mechanism 900 can engage with (e.g., contact, interact with, touch, press against) a second region 930 of the second member 220. For example, the second region 930 can be an area, a surface, a recessed portion, or some other part of the second member 220 that can correspond with the second portion 910 of the clamping mechanism 900. As depicted in FIG. 9, among others, the second region 930 can extend from the first member 205. The first portion 905 can interact with the first region 925 and the second portion 910 can interact with the second region 930 with the clamping mechanism 900 coupled with (e.g., secured to) the first member 205 and the second member 220. For example, the first portion 905 can interact with the first region 925 and the second portion 910 can interact with the second region 930 with the first member 205 or the second member 220 applying a pressure to the electrode stack 100 to maintain an alignment of the electrolyte layer 115 with the electrode layer (e.g., the anode layer 120 or the cathode layer 125).

The grasping portion 920 can be a handle or some other member extending from the first portion 905, the second portion 910, or the side portion 915. The grasping portion 920 can facilitate an actuation of the clamping mechanism 900. For example, the grasping portion 920 can include an actuator that, when actuated, can cause the clamping mechanism 900 to apply a clamping force to the first member 205 or the second member 220. The grasping portion 920 can facilitate a movement of the holder 200. For example, an operator, an actuator (e.g., the actuator 230) can grasp (e.g., grab, lift, cling to) the grasping portion 920 of the clamping mechanism 900 with the clamping mechanism 900 coupled with (e.g., secured to) the first member 205 or the second member 220 to move the holder 200 from a first position (e.g., the stacking surface 215) to a second position (e.g., the bottom plate 240 of the heat press 235).

The holder 200 can include a third member defining a cavity to receive the first member and the second member with the first member supporting the first side of the electrode stack and the second member supporting the second side of the electrode stack. For example, the holder 200 can include a third member 935 defining a cavity 940. The cavity 940 can be an impression, opening, void, or space within the third member 935. The third member 935 can include a cutout 945. The cavity 940 can include at least one dimension to accommodate the first member 205 or the second member 220 of the holder 200. For example, the first member 205 or the second member 220 can fit within the cavity 940 of the third member 935 with the electrode stack 100 supported by the first member 205 and the second member. The first member 205 or the second member 220 can fit within the cavity 940 of the holder 200 with the clamping mechanism 900 coupled with the first member 205 or the second member 220 to secure the first member 205 with the second member 220. For example, the clamping mechanism 900 or the grasping portion 920 of the clamping mechanism 900 can extend from the cavity 940 through the cutout 945 such that the grasping portion 920 does not contact (e.g., collide with, interfere with) the third member 935 with the first member 205 and the second member 220 positioned within the cavity 940.

The holder 200 can include the third member 935 having a thermally insulative material to retain heat within the cavity 940. The third member 935 can be positioned on (e.g., coupled with, resting against) the heat press 235. For example, the first member 205, the second member 220, and the electrode stack 100 positioned between the first member 205 and the second member 220 can be received in the cavity 940 of the third member 935 with the third member 935 positioned on the bottom plate 240 of the heat press 235. The top plate 245 and the bottom plate 240 of the heat press 235 can contact (e.g., apply a force to, press against) the third member 935 during the heat press operation. For example, the heat press operation can occur with the third member 935 between the top plate 245 and the bottom plate 240 of the heat press 235 and with the first member 205, the second member 220, and the electrode stack 100 positioned within the cavity 940 of the third member 935. The third member 935 can include a thermally insulative material to receive heat from the heat press and to store heat. For example, the third member 935 can store heat energy to provide heat energy to the electrode stack 100 within the cavity 940 and between the first member 205 and the second member 220 for a period of time (e.g., a period of time that is greater than a period of time during which heat would be provided to the electrode stack 100 if the third member 935 of were not present). The third member 935 can receive heat energy from the heat press 235 and store the heat energy within the thermally insulative material of the third member 935 to provide heat to the electrode stack 100. For example, the third member 935 can receive heat energy from the bottom plate 240 or the top plate 245 of the heat press 235 during the heat press operation with first member 205 and the second member 220 within the cavity 940 and with the electrode stack 100 positioned between the first member 205 and the second member 220. After the heat press operation concludes (e.g., after the heat press 235 ceases to apply a pressure to the holder 200), the stored heat energy within the third member 935 can provide heat to the electrode stack 100 with the first member 205, the second member 220 and the electrode stack 100 at least partially within the cavity 940 of the third member 935.

As depicted in FIGS. 6-11, among others, the holder 200 can include at least one magnet or at least one magnetic material. For example, the clamping mechanism can include at least one magnet. The clamping mechanism can include the magnet to create a magnetic attraction with at least one of the first member 205 or the second member 220. The magnetic attraction (e.g., a magnetic force) can facilitate an application of pressure to the electrode stack 100. For example, the magnetic attraction created by the clamping mechanism can apply a pressure to the electrode stack 100 between the first member 205 or the second member 220 to maintain alignment of the electrolyte layer 115 with an electrode layer (e.g., the anode layer 120 or the cathode layer 125). The magnetic attraction created by the clamping mechanism can cause the first member 205 to apply a pressure (e.g., a force) in the direction 275 to the first side 105 of the electrode stack 100 with the first side 105 supported by the first member 205 and the second side 110 supported by the second member 220. The magnetic attraction created by the clamping mechanism can cause the second member 220 to apply a pressure (e.g., a force) in the direction 280 to the second side 110 of the electrode stack 100 with the second side 110 supported by the second member 220 and the first side 105 supported by the first member 205. The first member 205 or the second member 220 can be or include a magnetic material to interact with a magnet or magnetic material of the clamping mechanism. The magnetic material or magnet of the first member 205, the second member 220, or the clamping mechanism can be a permanent magnet, such as a ferrite magnet, a neodymium magnet, or some other type of magnet. The magnetic material or magnet of the first member 205, the second member 220, or the clamping mechanism can be an electromagnet or some other magnet (e.g., a temporary magnet).

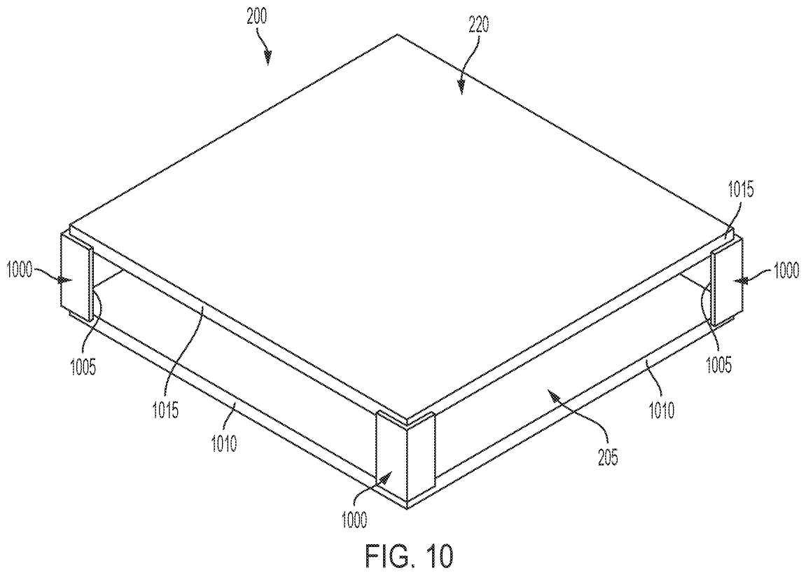

For example, as depicted in FIG. 10, among others, the holder 200 can include at least one clamping mechanism 1000. The clamping mechanism 1000 can be or include at least one magnet. For example the clamping mechanism 1000 can include at least one magnet to interact with the first member 205 or the second member 220. The clamping mechanism 1000 can interact with the first member 205 or the second member 220 via a magnetic attraction or magnetic force to cause the second member 220 or the first member 205 to apply a pressure to the electrode stack 100 to maintain an alignment of the electrolyte layer 115 with the electrode layer (e.g., the anode layer 120 or the cathode layer 125). For example, a magnetic attraction between the clamping mechanism 1000 and the first member 205 and a magnetic attraction between the clamping mechanism 1000 and the second member 220 can hold (e.g., keep, retain) the first member 205 and the second member 220 predetermined distance away from each other. The first member 205 or the second member 220 can apply a pressure (e.g., a force) to the electrode stack 100 with the first member 205 located the predetermined distance from the second member 220 via the clamping mechanism 1000. The clamping mechanism 1000 can be positioned at a corner of the holder 200, along a side of the holder, or in some other position on the holder 200 with the clamping mechanism 1000 coupled with the first member 205 or the second member 220. For example, the clamping mechanism 1000 can include a coupling surface 1005 to interact with (e.g., touch, abut, contact) an edge 1010 of the first member 205 or an edge 1015 of the second member 220. For example, the clamping mechanism 1000 can be a V-shaped or L-shaped member positioned at (e.g., around) a corner of the holder 200. The coupling surface 1005 can interact with at least a portion of the edge 1010 of the first member 205 and at least a portion of the edge 1015 of the second member 220 to secure the first member 205 with the second member 220. For example, the first member 205 or the second member 220 can be or include a magnetic material to interact via magnetic attraction with a magnet of the clamping mechanism 1000. The clamping mechanism 1000 can include at least one magnet to include a magnetic field at least partially extending from the coupling surface 1005 of the clamping mechanism 1000. The magnetic field extending from the coupling surface 1005 of the clamping mechanism 1000 can interact with the magnetic material of the first member 205 and the magnetic material of the second member 220 magnetically interact with the first member 205 or the second member 220. The first member 205 or the second member 220 can apply a pressure to the electrode stack 100 with the clamping mechanism 1000 magnetically interacting with the first member 205 and the second member 220.

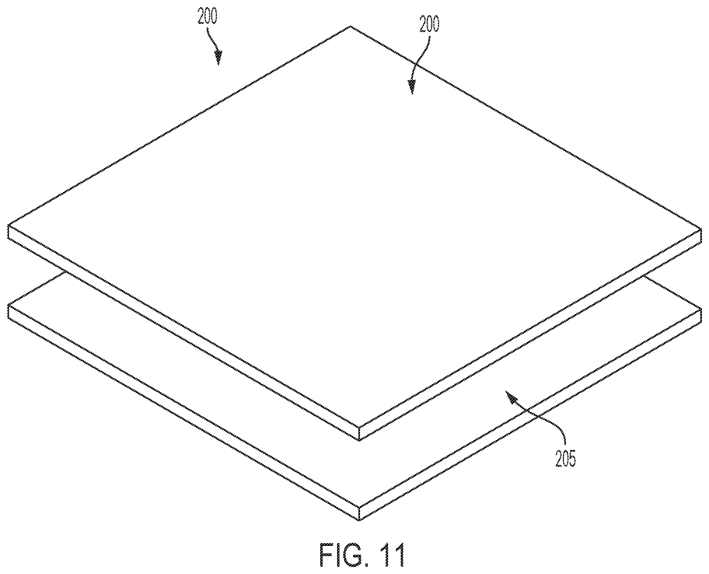

As depicted in FIG. 11, among others, the holder 200 can include the first member 205 or the second member 220 being or including a magnetic material or magnet. For example, the first member 205 can be or include a magnetic material and the second member 220 can be or include a magnetic material, where the first member 205 can be magnetically attracted to the second member 220. The magnetic material or magnet of the first member 205 or the second member 220 can be a permanent magnet, such as a ferrite magnet, a neodymium magnet, or some other type of magnet. The magnetic material or magnet of the first member 205 or the second member 220 can be an electromagnet or some other magnet (e.g., a temporary magnet). The magnetic material or magnet of the first member 205 can be magnetically attracted to the magnetic material or magnet of the second member 220 to cause the first member 205 to be magnetically attracted to the second member 220. For example, the first member 205 or the second member 220 can apply a pressure (e.g., a force) to the electrode stack 100 positioned between the first member 205 and the second member 220 with the first member 205 magnetically attracted to the second member 220. The pressure applied to the electrode stack 100 via the magnetic attraction between the first member 205 and the second member 220 can maintain the alignment of the electrolyte layer 115 with the electrode layer (e.g., the anode layer 120 or the cathode layer 125).

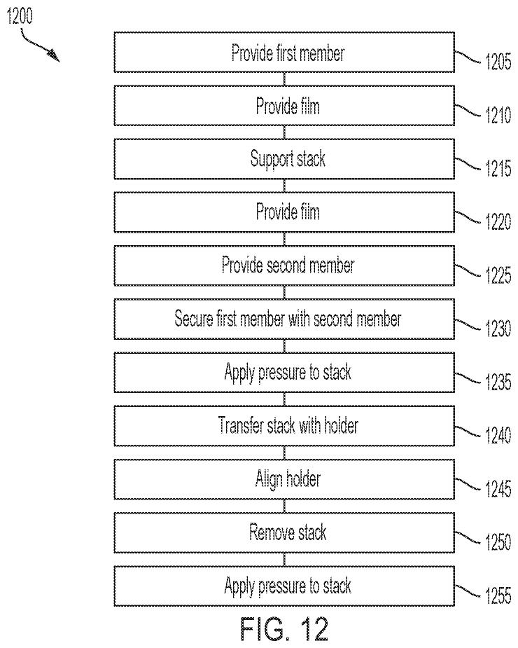

FIG. 12, among others, depicts a flow chart for a method 1200. The method 1200 can be a method of manufacturing a battery or battery cell. For example, method 1200 can be a method of using a holder 200 during manufacture of a battery cell. The method 1200 can be performed by one or more operators (e.g., a human operator), one or more robotic devices (e.g., a robotic pick-and-place actuator), or some other device, apparatus, or mechanism (e.g., the holder 200). The method 1200 can include one or more of ACTS 1205-1255. Each of ACTS 1205-1255 can be optional. The ACTS 1205-1255 can be performed in an order shown in FIG. 12 or in some other order.

The method 1200 can include providing a first member at ACT 1205. For example, the method 1200 can include providing the first member 205 of the holder 200 at ACT 1205. The first member 205 can be a bottom-most member of the holder 200. The first member 205 can include the cavity 210. The cavity 210 can at least partially enclose the electrode stack 100 with the electrode stack 100 positioned on the first member 205 or within the cavity 210. The first member 205 can be provided to (e.g., placed on, positioned at) a first position. For example, the first position can be the stacking surface 215. The first member 205 can be positioned on the stacking surface 215 in an orientation to receive the electrode stack 100. For example, the first member 205 can be positioned on the stacking surface 215 in an orientation where the cavity 210 is accessible such that the layers of the electrode stack 100 can be provided into the cavity 210. The first member 205 can be positioned to support the first side 105 of the electrode stack 100, for example.

The method 1200 can include providing a film at ACT 1210. For example, the method 1200 can include providing the film 130 at ACT 1210. The film 130 can be provided to the first member 205 of the holder 200. For example, after the first member 205 of the holder 200 is provided at ACT 1205, the film 130 (e.g., a layer, sheet, leaf, singulated portion) can be provided onto the first member 205. If the first member 205 includes a cavity 210, the film 130 can be provided within the cavity 210. The film 130 can be or include a film to protect the first member 205 of the holder 200, the electrode stack 100, or one or more layers of the electrode stack 100 (e.g., the electrolyte layer 115). The film 130 can be or include a material to prevent corrosion of the first member 205 with the first member 205 supporting the first side 105 of the electrode stack 100. For example, the film 130 can act as a barrier between the first side 105 of a subsequently-placed electrode stack (e.g., the electrolyte layer 115 of the electrode stack 100) and the first member 205 to prevent corrosion of the first member 205. The film 130 can be a disposable film. The film 130 can be a temporary processing film.

The method 1200 can include supporting a stack at ACT 1215. For example, the method 1200 can include supporting the electrode stack 100 at ACT 1215. The electrode stack 100 can be provided to (e.g., placed on, stacked against) the first member 205. The electrode stack 100 can be provided to (e.g., placed on, stacked against) the film 130 with the film 130 positioned on first member 205. The electrolyte layer 115, anode layer 120, or cathode layer 125 of the electrode stack 100 can be provided to the first member 205 such that each of the electrolyte layer 115, anode layer 120, and cathode layer 125 can be supported by the first member 205. The electrolyte layer 115, anode layer 120, cathode layer 125, or film 130 can be provided to the first member 205 in some sequence (e.g., as a singulated layer, sheet, or leaf) to create the electrode stack 100. For example, the electrolyte layer 115, anode layer 120, cathode layer 125, or film 130 can be provided to the first member 205 individually. The electrolyte layer 115, anode layer 120, cathode layer 125, or film 130 can be provided to the first member 205 two layers at a time, such as a half-cell including an electrolyte layer 115 joined with (e.g., laminated with, adhered to, otherwise joined with) a cathode layer 125 or an anode layer 120. The electrolyte layer 115, anode layer 120, cathode layer 125, or film 130 can be provided to the first member 205 four layers at a time, such as a monocell including two electrolyte layers 115, an anode layer 120, and a cathode layer 125. The electrolyte layer 115, anode layer 120, or the cathode layer 125, can be provided to the first member 205 to create the electrode stack 100 such that the resultant electrode stack 100 can include the alignment of the electrolyte layer 115 with the anode layer 120 or the cathode layer 125. For example, the alignment of the electrolyte layer 115 with the electrode layer can include at least one edge 135 of the electrolyte layer 115 aligned (e.g., flush, uniform) with at least one edge 140, 145 of the anode layer 120 or the cathode layer 125, respectively.

The method 1200 can include providing a film at ACT 1220. For example, the method 1200 can include providing the film 130 at ACT 1220. The film 130 can be provided to the second side 110 of the electrode stack 100. For example, after the electrode stack 100 is provided and supported on the first member 205 at ACT 1215, the film 130 (e.g., a layer, sheet, leaf, singulated portion) can be provided onto (e.g., over, at least partially over) the second side 110 of the electrode stack 100. The film 130 can be or include a film to protect the electrode stack 100, one or more layers of the electrode stack 100 (e.g., the electrolyte layer 115), or an object in contact with the second side 110 of the electrode stack 100 (e.g., the second member 220). The film 130 can be or include a material to prevent corrosion of the second member 220 with the second member 220 supporting the second side 110 of the electrode stack 100. For example, the film 130 can act as a barrier between the second side 110 of the electrode stack (e.g., the electrolyte layer 115 of the electrode stack 100) and the subsequently-placed second member 220 to prevent corrosion of the second member 220. The film 130 can be a disposable film. The film 130 can be a temporary processing film.

The method 1200 can include providing a second member at ACT 1225. For example, the method 1200 can include providing the second member 220 at ACT 1225. The second member 220 can be provided to the second side 110 of the electrode stack 100 such that the second member 220 is supporting the second side 110 of the electrode stack 100. The second member 220 can be provided to the electrode stack 100 after the electrolyte layer 115, anode layer 120, cathode layer 125, or film 130 are provided to the first member 205 to create the electrode stack 100 on the first member 205 at ACT 1215. The second member 220 can be provided to the second side 110 of the electrode stack 100 with the second member 220 in an orientation. For example, the second member 220 can be provided to the electrode stack 100 with a center point, edge, or other feature aligned with a feature (e.g., a center point, edge, cutout, or other feature of the first member 205. The second member 220 can contact (e.g., abut, touch, be positioned directly or indirectly against) the second side 110 of the electrode stack 100 as the second member 220 first within a cavity of the first member or some other member (e.g., a third member) of the holder 200. The second member 220 can support the second side 110 of the electrode stack 100 with the second member 220 position on (e.g., against, abutting, touching, directly or indirectly contacting) the second side 110 of the electrode stack 100.

The method 1200 can include securing the first member with the second member at ACT 1230. For example, the method 1200 can include securing the first member 205 with the second member 220 with at least one clamping mechanism at ACT 1230. The clamping mechanism can secure the first member 205 with the second member 220 with the electrode stack 100 between the first member 205 and the second member 220. The clamping mechanism can couple the first member 205 with the second member 220 such that the first member 205 and the second member 220 are drawn towards each other to apply (e.g., facilitate an application of) a pressure or force to the electrode stack 100. For example, the clamping mechanism can apply a force in one or both of the direction 275 or the direction 280 to squeeze the first member 205 towards the second member 220. The force applied by the clamping mechanism can apply a pressure to the electrode stack 100 positioned within the holder 200. For example, the force applied by the clamping mechanism can cause the first member 205 to apply a force to (e.g., against) the first side 105 of the electrode stack 100 and cause the second member 220 to apply a force to (e.g., against) the second side 110 of the electrode stack 100. The pressure (e.g., force) applied to at least one of the first side 105 and the second side 110 of the electrode stack 100 can prevent a layer of the electrode stack 100 from moving with respect to at least one other layer of the electrode stack 100. The clamping mechanism can be a mechanical clamping mechanism (e.g., a clamp, fasteners, or some other device), a magnetic clamping mechanism (e.g., one or more magnets or magnetic materials interacting via magnetic attraction), or some other mechanism. For example, the clamping mechanism can be one or more of the clamping mechanism of FIGS. 4-10 or some other mechanism.

The method 1200 can include applying pressure to the stack at ACT 1235. For example, the method 1200 can include applying a pressure to the electrode stack 100 at ACT 1245. The electrode stack 100 can be supported by the first member 205 and the second member 220 of the holder 200. For example, the first side 105 of the electrode stack 100 can be supported by the first member 205 and the second side 110 of the electrode stack 100 can be supported by the second member 220. The electrode stack 100 can be positioned between the first member 205 and the second member 220. The first member 205 can contact (e.g., abut, touch, be positioned directly or indirectly against) the first side 105 of the electrode stack 100 and the second member 220 can contact (e.g., abut, touch, be positioned directly or indirectly against) the second side 110 of the electrode stack 100. For example, a gravitational force or some other applied force, such as a clamping pressure or force applied by a clamping mechanism can be applied to at least one of the first member 205 or the second member 220. That force can apply a pressure (e.g., a force) to the electrode stack 100 with the electrode stack 100 between the first member 205 and the second member 220. The pressure applied to the electrode stack 100 can be a compressive force to hold the layers of the electrode stack 100 in a position such that an individual layer of the electrode stack 100 cannot move or is substantially prevented from moving (e.g., ±90% reduction in movement) with respect to an adjacent layer or some other layer. An orientation or alignment of the layers of the electrode stack 100 can be substantially preserved (e.g., ±90% preserved) with the pressure applied to the electrode stack 100 to prevent or substantially prevent a movement of the layers of the electrode stack 100. For example, the pressure applied to the electrode stack 100 can prevent the electrolyte layer 115 from moving with respect to the anode layer 120 or the cathode layer 125 such that the alignment of the electrolyte layer 115 with the electrode layer (e.g., the anode layer 120 or the cathode layer 125) is maintained (e.g., preserved, remains unchanged as the electrode stack 100 is moved).

The method 1200 can include transferring the stack within the holder at ACT 1240. For example, the method 1200 can include transferring the electrode stack 100 from a first position to a second position with the electrode stack 100 within the holder 200 (e.g., supported by the first member 205 or the second member 220 of the holder 200). The actuator 230 can move the electrode stack 100 from a first position to a second position. For example, the actuator 230 can move the electrode stack 100 from a first position to a second position with the electrode stack 100 supported by the first member 205 and the second member 220. The actuator 230 can move the electrode stack 100 from a first position to a second position with the first member 205 or the second member 220 applying a pressure to the electrode stack 100 to maintain alignment of the electrolyte layer 115 with the electrode layer (e.g., the anode layer 120 or the cathode layer 125). The first position can be the stacking surface 215. The second position can be a bottom plate 240 of a heat press 235, for example. The actuator 230 can be or include a mandrel, a robotic pick-and-place actuator, a conveyor device, a vacuum-operated pick-and-place robot, or some other actuator. For example, the actuator 230 can grasp the holder 200 with the electrode stack 100 between the first member 205 and the second member 220 of the holder 200. The actuator 230 can lift the holder 200 and the electrode stack 100 from the first location (e.g., the stacking surface 215) and move the holder 200 and the electrode stack 100 to the second location (e.g., the bottom plate 240 of the heat press 235). The alignment of the electrolyte layer 115 with the electrode layer (e.g., the anode layer 120 or the cathode layer 125) can be maintained or substantially maintained (e.g., ±95% maintained) during movement of the electrode stack 100 at ACT 1240.

The method 1200 can include aligning the holder at ACT 1245. For example, the method 1200 can include aligning the holder 200 at a second positioned at ACT 1245. The holder 200 can include at least one alignment mechanism 600. The alignment mechanism 600 can align the first member 205 with a surface (e.g., the bottom plate 240 of the heat press 235). For example, the alignment mechanism 600 can be a pin, a locator, a slot, a groove, a key or keyway, or some other feature. The alignment mechanism 600 can interact with a corresponding feature on the heat press 235 or other object or surface. For example, the bottom plate 240 of the heat press 235 can include an aperture to receive a pin, a locator, a protrusion to be received in a slot or groove, a keyway or key, or some other feature that can mate with or correspond with the alignment mechanism 600 of the holder 200. The alignment mechanism 600 can engage or interact with a corresponding feature of another object (e.g., the heat press 235) to align the holder 200 relative to the other object. The alignment mechanism 600 can align the first member 205, the second member 220, and the electrode stack 100 in the second position to facilitate a subsequent operation (e.g., a heat press operation).

The method 1200 can include removing the stack at ACT 1250. For example, the method 1200 can include removing the electrode stack 100 from the holder 200 at ACT 1250. As depicted in FIG. 3, among others, the electrode stack 100 can be removed from the holder 200 at interval 300. For example, the electrode stack 100 can be transferred (e.g., moved) from one positioned (e.g., the stacking surface 215) to another position (e.g., an intermediate position) with the first side 105 of the electrode stack 100 supported by the first member 205 and the second side 110 supported by the second member 220. The electrode stack 100 can be removed from holder 200 via at least one actuator 230. For example, an actuator 230 can remove the second member 220 from the second side 110 of the electrode stack 100 such that an actuator 230 can access the electrode stack 100 to remove (e.g., grab, lift, retrieve, move) the electrode stack 100 from the first member 205. The actuator 230 can move the electrode stack 100 from the first member 205 with the electrode stack 100 and the holder 200 in an intermediate position between the stacking surface 215 and the bottom plate 240 of the heat press 235. The intermediate position can be some position proximate to (e.g., within 1 meter, within 25 centimeters, or at some other distance) from the heat press such that the actuator 230 can retrieve the electrode stack 100 and place the electrode stack 100 in the second position (e.g., the bottom plate 240 of the heat press 235).

The method 1200 can include applying pressure to the stack at ACT 1255. For example, the method 1200 can include applying a second pressure to the electrode stack 100 at ACT 1255. The second pressure can be applied by the heat press 235. For example, the top plate 245 can move in the direction 280 towards the bottom plate 240 of the heat press 235 to apply the second pressure (e.g., a force) to the electrode stack 100 positioned between the top plate 245 and the bottom plate 240 of the heat press 235. The bottom plate 240 can move in the direction 275 towards the top plate 245 of the heat press 235 to apply the second pressure (e.g., a force) to the electrode stack 100 positioned between the top plate 245 and the bottom plate 240 of the heat press 235. Both the top plate 245 and the bottom plate 240 can move towards each other to apply the second pressure to the electrode stack 100. The heat press 235 can apply the second pressure to the electrode stack 100 with the electrode stack 100 positioned within the holder 200. For example, the heat press 235 can apply the second pressure to the electrode stack 100 via the holder 200 with the first side 105 of the electrode stack 100 supported by the first member 205 and the second side 110 supported by the second member 220 of the holder. The heat press 235 can apply the second pressure to the electrode stack 100 with the electrode stack 100 removed from the holder 200. For example, the electrode stack 100 can be removed from the holder 200 at ACT 1250 and placed on the bottom plate 240 of the heat press 235 such that the top plate 245 or bottom plate 240 of the heat press 235 can act against (e.g., apply the second pressure to) the electrode stack 100 directly.

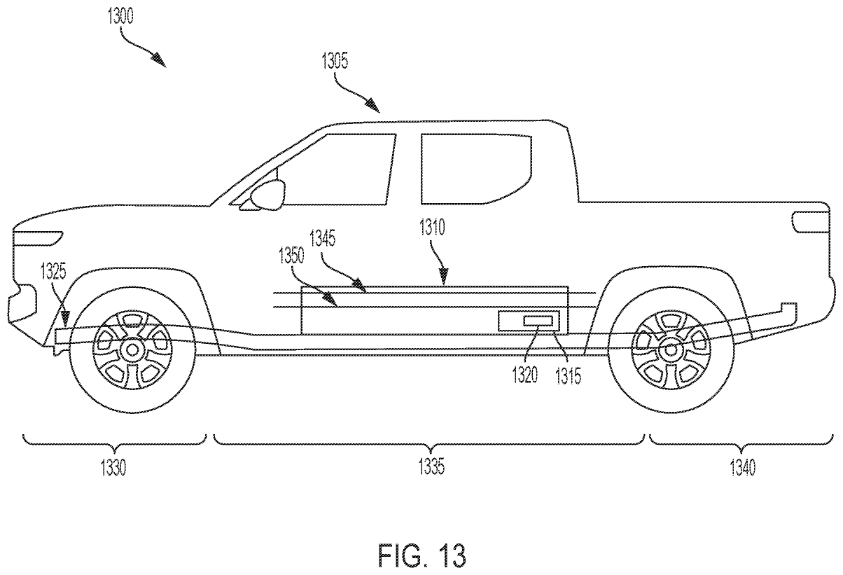

FIG. 13 depicts an example cross-sectional view 1300 of an electric vehicle 1305 installed with at least one battery pack 1310. Electric vehicles 1305 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 1310 can also be used as an energy storage system to power a building, such as a residential home or commercial building. Electric vehicles 1305 can be fully electric or partially electric (e.g., plug-in hybrid) and further, electric vehicles 1305 can be fully autonomous, partially autonomous, or unmanned. Electric vehicles 1305 can also be human operated or non-autonomous. Electric vehicles 1305 such as electric trucks or automobiles can include on-board battery packs 1310, batteries 1315 or battery modules 1315, or battery cells 1320 to power the electric vehicles. The electric vehicle 1305 can include a chassis 1325 (e.g., a frame, internal frame, or support structure). The chassis 1325 can support various components of the electric vehicle 1305. The chassis 1325 can span a front portion 1330 (e.g., a hood or bonnet portion), a body portion 1335, and a rear portion 1340 (e.g., a trunk, payload, or boot portion) of the electric vehicle 1305. The battery pack 1310 can be installed or placed within the electric vehicle 1305. For example, the battery pack 1310 can be installed on the chassis 1325 of the electric vehicle 1305 within one or more of the front portion 1330, the body portion 1335, or the rear portion 1340. The battery pack 1310 can include or connect with at least one busbar, e.g., a current collector element. For example, the first busbar 1345 and the second busbar 1350 can include electrically conductive material to connect or otherwise electrically couple the battery 1315, the battery modules 1315, or the battery cells 1320 with other electrical components of the electric vehicle 1305 to provide electrical power to various systems or components of the electric vehicle 1305.

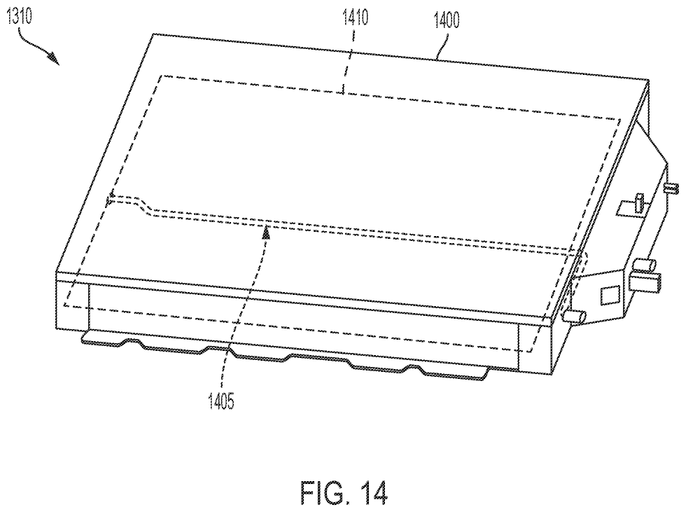

FIG. 14 depicts an example battery pack 1310. Referring to FIG. 14, among others, the battery pack 1310 can provide power to electric vehicle 1305. Battery packs 1310 can include any arrangement or network of electrical, electronic, mechanical or electromechanical devices to power a vehicle of any type, such as the electric vehicle 1305. The battery pack 1310 can include at least one housing 1400. The housing 1400 can include at least one battery module 1315 or at least one battery cell 1320, as well as other battery pack components. The battery module 1315 can be or can include one or more groups of prismatic cells, cylindrical cells, pouch cells, or other form factors of battery cells 1320. The housing 1400 can include a shield on the bottom or underneath the battery module 1315 to protect the battery module 1315 and/or cells 1320 from external conditions, for example if the electric vehicle 1305 is driven over rough terrains (e.g., off-road, trenches, rocks, etc.) The battery pack 1310 can include at least one cooling line 1405 that can distribute fluid through the battery pack 1310 as part of a thermal/temperature control or heat exchange system that can also include at least one thermal component (e.g., cold plate) 1410. The thermal component 1410 can be positioned in relation to a top submodule and a bottom submodule, such as in between the top and bottom submodules, among other possibilities. The battery pack 1310 can include any number of thermal components 1410. For example, there can be one or more thermal components 1410 per battery pack 1310, or per battery module 1315. At least one cooling line 1405 can be coupled with, part of, or independent from the thermal component 1410.

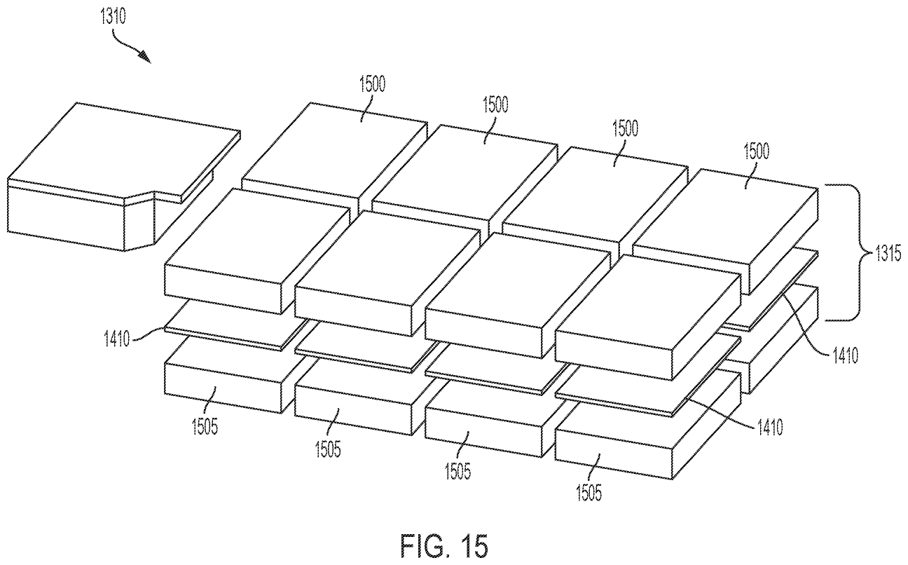

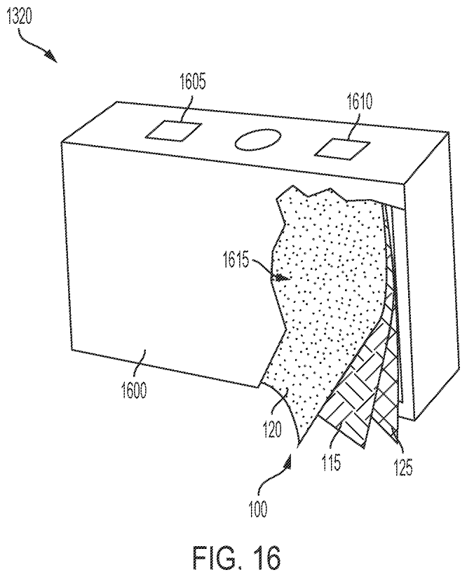

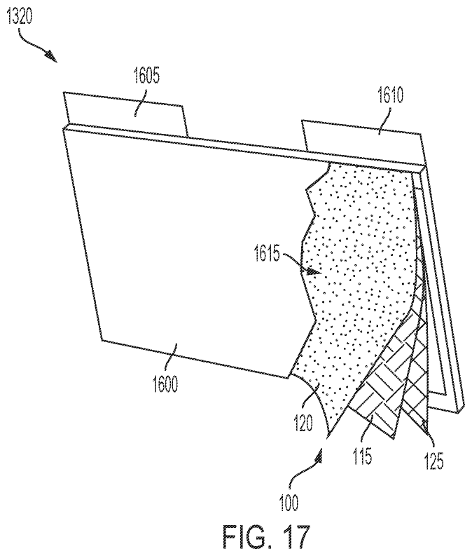

FIG. 15 depicts example battery modules 1315, and FIGS. 16 and 17 depict an example cross sectional view of a battery cell 1320. The battery modules 1315 can include at least one submodule. For example, the battery modules 1315 can include at least one first (e.g., top) submodule 1500 or at least one second (e.g., bottom) submodule 1505. At least one thermal component 1410 can be disposed between the top submodule 1500 and the bottom submodule 1505. For example, one thermal component 1410 can be configured for heat exchange with one battery module 1315. The thermal component 1410 can be disposed or thermally coupled between the top submodule 1500 and the bottom submodule 1505. One thermal component 1410 can also be thermally coupled with more than one battery module 1315 (or more than two submodules 1500, 1505). The thermal components 1410 shown adjacent to each other can be combined into a single thermal component 1410 that spans the size of one or more submodules 1500 or 1505. The thermal component 1410 can be positioned underneath submodule 1500 and over submodule 1505, in between submodules 1500 and 1505, on one or more sides of submodules 1500, 1505, among other possibilities. The thermal component 1410 can be disposed in sidewalls, cross members, structural beams, among various other components of the battery pack, such as battery pack 1310 described above. The battery submodules 1500, 1505 can collectively form one battery module 1315. In some examples each submodule 1500, 1505 can be considered as a complete battery module 1315, rather than a submodule.

The battery modules 1315 can each include a plurality of battery cells 1320. The battery modules 1315 can be disposed within the housing 1400 of the battery pack 1310. The battery modules 1315 can include battery cells 1320 that are cylindrical cells or prismatic cells, for example. The battery module 1315 can operate as a modular unit of battery cells 1320. For example, a battery module 1315 can collect current or electrical power from the battery cells 1320 that are included in the battery module 1315 and can provide the current or electrical power as output from the battery pack 1310. The battery pack 1310 can include any number of battery modules 1315. For example, the battery pack can have one, two, three, four, five, six, seven, eight, nine, ten, eleven, twelve or other number of battery modules 1315 disposed in the housing 1400. It should also be noted that each battery module 1315 may include a top submodule 1500 and a bottom submodule 1505, possibly with a thermal component 1410 in between the top submodule 1500 and the bottom submodule 1505. The battery pack 1310 can include or define a plurality of areas for positioning of the battery module 1315 and/or cells 1320. The battery modules 1315 can be square, rectangular, circular, triangular, symmetrical, or asymmetrical. In some examples, battery modules 1315 may be different shapes, such that some battery modules 1315 are rectangular but other battery modules 1315 are square shaped, among other possibilities. The battery module 1315 can include or define a plurality of slots, holders, or containers for a plurality of battery cells 1320. It should be noted the illustrations and descriptions herein are provided for example purposes and should not be interpreted as limiting. For example, the battery cells 1320 can be inserted in the battery pack 1310 without battery modules 1500 and 1505. The battery cells 1320 can be disposed in the battery pack 1310 in a cell-to-pack configuration without modules 1500 and 1505, among other possibilities.

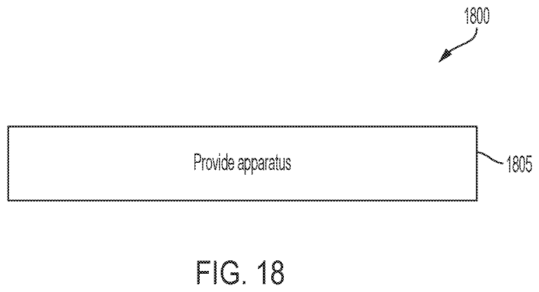

Battery cells 1320 have a variety of form factors, shapes, or sizes. For example, battery cells 1320 can have a cylindrical, rectangular, square, cubic, flat, pouch, elongated or prismatic form factor. As depicted in FIG. 16, for example, the battery cell 1320 can be prismatic. As depicted in FIG. 18, for example, the battery cell 1320 can include a pouch form factor. Battery cells 1320 can be assembled, for example, by inserting a winded or stacked electrode roll (e.g., a jelly roll) including electrolyte material into at least one battery cell housing 1600. The electrolyte material, e.g., an ionically conductive fluid or other material, can support electrochemical reactions at the electrodes to generate, store, or provide electric power for the battery cell by allowing for the conduction of ions between a positive electrode and a negative electrode. The battery cell 1320 can include an electrolyte layer where the electrolyte layer can be or include solid electrolyte material that can conduct ions. For example, the solid electrolyte layer can conduct ions without receiving a separate liquid electrolyte material. The electrolyte material, e.g., an ionically conductive fluid or other material, can support conduction of ions between electrodes to generate or provide electric power for the battery cell 1320. The housing 1600 can be of various shapes, including cylindrical or rectangular, for example. Electrical connections can be made between the electrolyte material and components of the battery cell 1320. For example, electrical connections to the electrodes with at least some of the electrolyte material can be formed at two points or areas of the battery cell 1320, for example to form a first polarity terminal 1605 (e.g., a positive or anode terminal) and a second polarity terminal 1610 (e.g., a negative or cathode terminal). The polarity terminals can be made from electrically conductive materials to carry electrical current from the battery cell 1320 to an electrical load, such as a component or system of the electric vehicle 1305.

For example, the battery cell 1320 can include at least one lithium-ion battery cell. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 1320 to separate the anode and cathode from each other and to facilitate transfer of lithium ions between the anode and cathode. It should be noted that battery cell 1320 can also take the form of a solid state battery cell developed using solid electrodes and solid electrolytes. Solid electrodes or electrolytes can be or include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr, La, and B═Al, Ti), garnet-type with formula A₃B₂(XO₄)₃ (A=Ca, Sr, Ba and X═Nb, Ta), lithium phosphorous oxy-nitride (LiₓPO_{y}N₂). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X═Cl, Br) like Li(PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

The battery cell 1320 can be included in battery modules 1315 or battery packs 1310 to power components of the electric vehicle 1305. The battery cell housing 1600 can be disposed in the battery module 1315, the battery pack 1310, or a battery array installed in the electric vehicle 1305. The housing 1600 can be of any shape, such as cylindrical with a circular, elliptical, or ovular base, among others. The shape of the housing 1600 can also be prismatic with a polygonal base, as shown in FIG. 16 among others. As shown in FIG. 17, among others, the housing 1600 can include a pouch form factor. The housing 1600 can include other form factors, such as a triangle, a square, a rectangle, a pentagon, and a hexagon, among others. In some embodiments, the battery pack may not include modules (e.g., module-free). For example, the battery pack can have a module-free or cell-to-pack configuration where the battery cells are arranged directly into a battery pack without assembly into a module.

The housing 1600 of the battery cell 1320 can include one or more materials with various electrical conductivity or thermal conductivity, or a combination thereof. The electrically conductive and thermally conductive material for the housing 1600 of the battery cell 1320 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 1600 of the battery cell 1320 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others. In examples where the housing 1600 of the battery cell 1320 is prismatic (e.g., as depicted in FIG. 16, among others), cuboidal, or various other shapes (e.g., round, cylindrical, elliptical, or otherwise), the housing 1600 can include a rigid or semi-rigid material such that the housing 1600 is rigid or semi-rigid (e.g., not easily deformed or manipulated into another shape or form factor). In examples where the housing 1600 includes a pouch form factor (e.g., as depicted in FIG. 17, among others), the housing 1600 can include a flexible, malleable, or non-rigid material such that the housing 1600 can be bent, deformed, manipulated into another form factor or shape.

The battery cell 1320 can include at least one anode layer 120, which can be disposed within the cavity 1615 defined by the housing 1600. The anode layer 120 can include a first redox potential. The anode layer 120 can receive electrical current into the battery cell 1320 and output electrons during the operation of the battery cell 1320 (e.g., charging or discharging of the battery cell 1320). The anode layer 120 can include an active substance. The active substance can include, for example, an activated carbon or a material infused with conductive materials (e.g., artificial or natural graphite, or blended), lithium titanate (Li₄Ti₅O₁₂), or a silicon-based material (e.g., silicon metal, oxide, carbide, pre-lithiated), or other lithium alloy anodes (Li—Mg, Li—Al, Li—Ag alloy etc.) or composite anodes consisting of lithium and carbon, silicon and carbon or other compounds. The active substance can include graphitic carbon (e.g., ordered or disordered carbon with sp² hybridization), Li metal anode, or a silicon-based carbon composite anode, or other lithium alloy anodes (Li—Mg, Li—Al, Li—Ag alloy etc.) or composite anodes consisting of lithium and carbon, silicon and carbon or other compounds. In some examples, an anode material can be formed within a current collector material. For example, an electrode can include a current collector (e.g., a copper foil) with an in situ-formed anode (e.g., Li metal) on a surface of the current collector facing the separator or solid-state electrolyte. In such examples, the assembled cell does not comprise an anode active material in an uncharged state.

The battery cell 1320 can include at least one cathode layer 125 (e.g., a composite cathode layer compound cathode layer, a compound cathode, a composite cathode, or a cathode). The cathode layer 125 can include a second redox potential that can be different than the first redox potential of the anode layer 120. The cathode layer 125 can be disposed within the cavity 1615. The cathode layer 125 can output electrical current out from the battery cell 1320 and can receive electrons during the discharging of the battery cell 1320. The cathode layer 125 can also receive lithium ions during the discharging of the battery cell 1320. Conversely, the cathode layer 125 can receive electrical current into the battery cell 1320 and can output electrons during the charging of the battery cell 1320. The cathode layer 125 can release lithium ions during the charging of the battery cell 1320.

The battery cell 1320 can include the electrolyte layer 115 disposed within the cavity 1615. For example, the electrolyte layer 115 can be a solid-state electrolyte layer. The electrolyte layer 115 can be arranged between the anode layer 120 and the cathode layer 125 to separate the anode layer 120 and the cathode layer 125. The electrolyte layer 115 can be a solid-state electrolyte layer. The electrolyte layer 115 can include or be made of a solid electrolyte material, such as a ceramic electrolyte material, polymer electrolyte material, or a glassy electrolyte material, or among others, or any combination thereof. The electrolyte layer 115 can include a liquid electrolyte material. For example, the electrolyte layer 115 include at least one layer of polymeric material (e.g., polypropylene, polyethylene, or other material) that is wetted (e.g., is saturated with, is soaked with, receives) a liquid electrolyte substance. The electrolyte layer 115 can be or include at least one layer of electrolyte material that is further wetted with (e.g., saturated with, soaked with, or receives) a liquid electrolyte substance. The liquid electrolyte material can include a lithium salt dissolved in a solvent. The lithium salt for the liquid electrolyte material for the electrolyte layer 115 can include, for example, lithium tetrafluoroborate (LiBF₄), lithium hexafluorophosphate (LiPF₆), and lithium perchlorate (LiClO₄), among others. The solvent can include, for example, dimethyl carbonate (DMC), ethylene carbonate (EC), and diethyl carbonate (DEC), among others. The electrolyte layer 115 can be a layer that can be wetted with a liquid electrolyte to form the electrolyte layer 115. For example, the liquid electrolyte can be diffused into the anode layer 120. The liquid electrolyte can be diffused into the cathode layer 125. The electrolyte layer 115 can help transfer ions between the anode layer 120 and the cathode layer 125. The electrolyte layer 115 can transfer Lit cations from the anode layer 120 to the cathode layer 125 during the discharge operation of the battery cell 1320. The electrolyte layer 115 can transfer lithium ions from the cathode layer 125 to the anode layer 120 during the charge operation of the battery cell 1320.

In some embodiments, the solid electrolyte film can include at least one layer of a solid electrolyte. Solid electrolyte materials of the solid electrolyte layer can include inorganic solid electrolyte materials (e.g., oxides, sulfides, phosphides, ceramics), solid polymer electrolyte materials, hybrid solid state electrolytes, or combinations thereof. In some embodiments, the solid electrolyte layer can include polyanionic or oxide-based electrolyte material (e.g., Lithium Superionic Conductors (LISICONs), Sodium Superionic Conductors (NASICONs), perovskites with formula ABO₃ (A=Li, Ca, Sr. La, and B═Al, Ti), garnet-type with formula A₃B₂(XO₄)₃ (A=Ca, Sr, Ba and X═Nb, Ta), lithium phosphorous oxy-nitride (LiₓPO_{y}N_{z}). In some embodiments, the solid electrolyte layer can include a glassy, ceramic and/or crystalline sulfide-based electrolyte (e.g., Li₃PS₄, Li₇P₃S₁₁, Li₂S—P₂S₅, Li₂S—B₂S₃, SnS—P₂S₅, Li₂S—SiS₂, Li₂S—P₂S₅, Li₂S—GeS₂, Li₁₀GeP₂S₁₂) and/or sulfide-based lithium argyrodites with formula Li₆PS₅X (X═Cl, Br) like Li₆PS₅Cl). Furthermore, the solid electrolyte layer can include a polymer electrolyte material (e.g., a hybrid or pseudo-solid state electrolyte), for example, polyacrylonitrile (PAN), polyethylene oxide (PEO), polymethyl-methacrylate (PMMA), and polyvinylidene fluoride (PVDF), among others.

In examples where the electrolyte layer 115 includes a liquid electrolyte material, the electrolyte layer 115 can include a non-aqueous polar solvent. The non-aqueous polar solvent can include a carbonate such as ethylene carbonate, propylene carbonate, diethyl carbonate, ethyl methyl carbonate, dimethyl carbonate, or a mixture of any two or more thereof. The electrolyte layer 115 can include at least one additive. The additives can be or include vinylidene carbonate, fluoroethylene carbonate, ethyl propionate, methyl propionate, methyl acetate, ethyl acetate, or a mixture of any two or more thereof. The electrolyte layer 115 can include a lithium salt material. For example, the lithium salt can be lithium perchlorate, lithium hexafluorophosphate, lithium bis(fluorosulfonyl)imide, lithium bis(trifluorosulfonyl)imide, or a mixture of any two or more thereof. The lithium salt may be present in the electrolyte layer 115 from greater than 0 M to about 1.5 M.

The redox potential of layers (e.g., the first redox potential of the anode layer 120 or the second redox potential of the cathode layer 125) can vary based on a chemistry of the respective layer or a chemistry of the battery cell 1320. For example, lithium-ion batteries can include an LFP (lithium iron phosphate) chemistry, an LMFP (lithium manganese iron phosphate) chemistry, an NMC (Nickel Manganese Cobalt) chemistry, an NCA (Nickel Cobalt Aluminum) chemistry, an OLO (Over Lithiated Oxide) chemistry, or an LCO (lithium cobalt oxide) chemistry for a cathode layer (e.g., the cathode layer 125). Lithium-ion batteries can include a graphite chemistry, a silicon-graphite chemistry, or a lithium metal chemistry for the anode layer (e.g., the anode layer 120).

For example, lithium-ion batteries can include an olivine phosphate (LIMPO₄, M=Fc and/or Co and/or Mn and/or Ni)) chemistry, LISICON or NASICON Phosphates (Li₃M₂(PO₄)₃ and LIMPO₄Ox, M=Ti, V, Mn, Cr, and Zr), for example lithium iron phosphate (LFP), lithium iron manganese phosphate (LMFP), layered oxides (LiMO₂, M=Ni and/or Co and/or Mn and/or Fe and/or Al and/or Mg) examples, NMC (Nickel Manganese Cobalt) chemistry, an NCA (Nickel Cobalt Aluminum) chemistry, or an LCO (lithium cobalt oxide) chemistry for a cathode layer, lithium rich layer oxides (Li₁₊ₓM₁₋ₓO₂) (Ni, and/or Mn, and/or Co), (OLO or LMR), spinel (LiMn₂O₄) and high voltage spinels (LiMn_{1.5}Ni_{0.5}O₄), disordered rock salt, Fluorophosphates Li₂FePO₄F (M=Fe, Co, Ni) and Fluorosulfates LiMSO₄F (M=Co, Ni, Mn) (e.g., the cathode layer 125). Lithium-ion batteries can include a graphite chemistry, a silicon-graphite chemistry, or a lithium metal chemistry for the anode layer (e.g., the anode layer 120). For example, a cathode layer having an LFP chemistry can have a redox potential of 3.4 V vs. Li/Li⁺, while an anode layer having a graphite chemistry can have a 0.2 V vs. Li/Li⁺ redox potential.

Electrode layers can include anode active material or cathode active material, commonly in addition to a conductive carbon material, a binder, or other additives as a coating on a current collector (metal foil). The chemical composition of the electrode layers can affect the redox potential of the electrode layers. For example, cathode layers (e.g., the cathode layer 125) can include medium to high-nickel content (50 to 80%, or equal to 80% Ni) lithium transition metal oxide, such as a particulate lithium nickel manganese cobalt oxide (“LiNMC”), a lithium nickel cobalt aluminum oxide (“LiNCA”), a lithium nickel manganese cobalt aluminum oxide (“LiNMCA”), or lithium metal phosphates like lithium iron phosphate (“LFP”) and lithium iron manganese phosphate (“LMFP”). Anode layers (e.g., the anode layer 120) can include conductive carbon materials such as graphite, carbon black, carbon nanotubes, and the like. Anode layers can include Super P carbon black material, Ketjen Black, Acetylene Black, SWCNT, MWCNT, graphite, carbon nanofiber, or graphene, for example.

Electrode layers can also include chemical binding materials (e.g., binders). Binders can include polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Binder materials can include agar-agar, alginate, amylose, Arabic gum, carrageenan, cascine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrylic acid (PAA), poly(methyl acrylate) (PMA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof.

Current collector materials (e.g., a current collector foil to which an electrode active material is laminated to form a cathode layer or an anode layer) can include a metal material. For example, current collector materials can include aluminum, copper, nickel, titanium, stainless steel, or carbonaceous materials. The current collector material can be formed as a metal foil. For example, the current collector material can be an aluminum (Al) or copper (Cu) foil. The current collector material can be a metal alloy, made of Al, Cu, Ni, Fe, Ti, or combination thereof. The current collector material can be a metal foil coated with a carbon material, such as carbon-coated aluminum foil, carbon-coated copper foil, or other carbon-coated foil material.

FIG. 18, among others, depicts a method 1800. The method 1800 can include providing an apparatus 200 at ACT 1805. For example, the apparatus 200 can be a holder 200. The holder 200 can include a first member 205. The first member 205 can support a first side 105 of an electrode stack 100. The holder 200 can include a second member 220. The second member 220 can support a second side 110 of the electrode stack 100. For example, the second member 220 can support the second side 110 of the electrode stack 100 with the first side 105 of the electrode stack 100 supported by the first member 205. The electrode stack 100 can be positioned between the first member 205 and the second member 220. The electrode stack 100 can include at least one electrolyte layer 115 (e.g., a solid-state electrolyte layer 115) and at least one electrode layer (e.g., an anode layer 120 and a cathode layer 125). The electrode stack 100 can include an alignment of the electrolyte layer 115 with the electrode layer. For example, the edge 135 of the electrolyte layer 115 can be aligned with the edge 140 of the anode layer 120 or an edge 145 of the cathode layer 125. The first member 205 or the second member 220 can apply a pressure to the electrode stack 100 to maintain the alignment of the electrolyte layer 115 with the electrode layer. For example, the holder 200 can maintain the alignment of the electrolyte layer 115 with the electrode layer as the electrode stack 100 is moved from one position (e.g., a stacking location) to a second position (e.g., a heat press location) with the first side 105 of the electrode stack 100 supported by the first member 205 and the second side 110 of the electrode stack 100 supported by the second member 220.

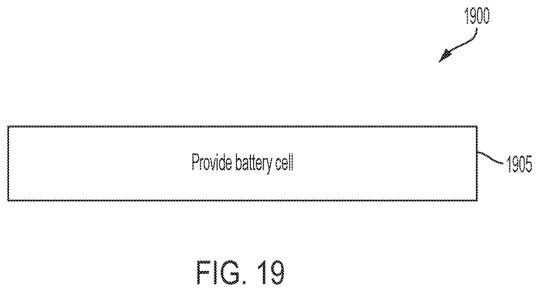

FIG. 19, among others, depicts a method 1900. The method 1900 can include providing a battery cell 1320 at ACT 1905. For example, the method 1900 can include providing the battery cell 1320 including an aligned electrode layer stack 100, the electrode stack 100. The electrode stack 100 can include at least one electrolyte layer 115 (e.g., a solid-state electrolyte layer 115), at least one anode layer 120, and at least one cathode layer 125. For example, the electrode stack 100 can include multiple anode layers 120 alternating with cathode layers 125 where an electrolyte layer 115 is positioned between adjacent anode layers 120 and cathode layers 125. The electrode stack 100 can include an alignment between the electrolyte layer 115 and at least one of the anode layer 120 and the cathode layer 125. For example, an edge 135 of the electrolyte layer 115 can be aligned with the edge 140 of the anode layer 120 or the edge 145 of the cathode layer 125. The alignment of the electrode stack 100 can be maintained with the electrode stack supported by the holder 200. For example, the holder 200 can include the first member 205 to support a first side 105 of the electrode stack 100. The holder 200 can include the second member 220 to support the second side 110 of the electrode stack 100. For example, the second member 220 can be provided on the second side 110 of the electrode stack 100 to support the electrode stack 100. A pressure can be applied by at least one of the first member 205 and the second member 220 to the electrode stack 100. The pressure applied to the electrode stack 100 by the first member 205 or the second member 220 can maintain the alignment of the electrolyte layer 115 with the anode layer 120 or the cathode layer 125. For example, the pressure applied to the electrode stack 100 by the first member 205 or the second member 220 can maintain the alignment of the electrolyte layer 115 with the anode layer 120 or the cathode layer 125 as the electrode stack 100 is moved from a first position (e.g., a stacking location) to a second position (e.g., a heat press location) while the electrode stack 100 is positioned within the holder 200 (e.g., between the first member 205 and the second member 220).

While operations are depicted in the drawings in an order, such operations are not required to be performed in the order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a first member to support a first side of an electrode stack, the electrode stack comprising a solid-state electrolyte layer and an electrode layer; and
a second member to support a second side of the electrode stack, at least one of the first member and the second member to apply a pressure to the electrode stack to maintain alignment of the solid-state electrolyte layer and the electrode layer.

2. The apparatus of claim 1, comprising:
the first member defining a cavity, the first member to support the first side of the electrode stack with the electrode stack within the cavity.

3. The apparatus of claim 1, comprising:
the first member defining a cavity, the first member to support the first side of the electrode stack with the electrode stack within the cavity; and
the first member including a thermally insulative material to retain heat within the cavity.

4. The apparatus of claim 1, comprising:
a third member defining a cavity, the first member to support the first side of the electrode stack with the first member and the electrode stack positioned within the cavity.

5. The apparatus of claim 1, comprising:
a third member defining a cavity, the first member to support the first side of the electrode stack with the first member and the electrode stack positioned within the cavity; and
the third member including a thermally insulative material to retain heat within the cavity.

6. The apparatus of claim 1, comprising:
a clamping mechanism to secure the first member with the second member with the electrode stack between the first member and the second member, the clamping mechanism to apply the pressure to the electrode stack to maintain alignment of the solid-state electrolyte layer and the electrode layer.

7. The apparatus of claim 1, comprising:
a clamping mechanism to secure the first member with the second member with the electrode stack between the first member and the second member, the clamping mechanism including a magnet to create a magnetic attraction with at least one of the first member and the second member, the magnetic attraction to apply the pressure to the electrode stack to maintain alignment of the solid-state electrolyte layer and the electrode layer.

8. The apparatus of claim 1, comprising:
a clamping mechanism to secure the first member with the second member with the electrode stack between the first member and the second member, the clamping mechanism to apply the pressure to the electrode stack to maintain alignment of the solid-state electrolyte layer and the electrode layer; and
an alignment mechanism to align the first member with a surface of a heat press, the heat press to apply a second pressure to the electrode stack with the first member supporting the first side of the electrode stack.

9. The apparatus of claim 1, comprising:
a clamping mechanism to secure the first member with the second member with the electrode stack between the first member and the second member, the clamping mechanism to apply the pressure to the electrode stack to maintain alignment of the solid-state electrolyte layer and the electrode layer;
an alignment mechanism to align the first member with a first surface of a heat press with the first member supporting the first surface of the electrode stack; and
the second member to engage with a second surface of the heat press, the heat press to apply a second pressure to the electrode stack with the first member, the electrode stack, and the second member positioned between the first surface and the second surface of the heat press.

10. The apparatus of claim 1, comprising:
the first member including at least one first magnet to interact with at least one second magnet of the second member, the interaction between the at least one first magnet and the at least one second magnet to create the pressure applied to the electrode stack to maintain alignment of the solid-state electrolyte layer and the electrode layer.

11. The apparatus of claim 1, comprising:
a clamping mechanism including a first portion to contact a first region of the first member and a second portion to contact a second region of the second member, the clamping mechanism to secure the first member with the second member with the electrode stack between the first member and the second member, the clamping mechanism to apply a clamping force to the first region of the first member and the second region of the second member to create the pressure applied to the electrode stack to maintain alignment of the solid-state electrolyte layer and the electrode layer.

12. The apparatus of claim 1, comprising:
a clamping mechanism to secure the first member with the second member with the electrode stack between the first member and the second member, the clamping mechanism to apply the pressure to the electrode stack to maintain alignment of the solid-state electrolyte layer and the electrode layer; and
a third member defining a cavity to receive the first member and the second member with the first member supporting the first side of the electrode stack and the second member supporting the second side of the electrode stack.

13. The apparatus of claim 1, comprising:
a clamping mechanism to secure the first member with the second member with the electrode stack between the first member and the second member, the clamping mechanism to apply the pressure to the electrode stack to maintain alignment of the solid-state electrolyte layer and the electrode layer;
a third member defining a cavity to receive the first member and the second member with the first member supporting the first side of the electrode stack and the second member supporting the second side of the electrode stack, the third member including a thermally insulative material to retain heat within the cavity.

14. A method, comprising:
supporting a first side of an electrode stack with a first member of a holder, the electrode stack comprising a solid-state electrolyte layer and an electrode layer;
providing a second member of the holder on a second side of the electrode stack; and
applying, via at least one of the first member or the second member, a pressure to the electrode stack to maintain alignment of the solid-state electrolyte layer and the electrode layer.

15. The method of claim 14, comprising:
transferring, via an actuator with the electrode stack supported by the first member and the second member of the holder, the electrode stack from a first position to a second position with the first member of the holder or the second member of the holder applying the pressure to the electrode stack to maintain alignment of the solid-state electrolyte layer and the electrode layer with the electrode stack in the second position.

16. The method of claim 14, comprising:
providing a first film between the first side of the electrode stack and the first member and a second film between the second side of the electrode stack and the second member, the first film and the second film to prevent the electrode stack from directly contacting the first member or the second member.

17. The method of claim 14, comprising:
applying, via a heat press, a second pressure and heat to the first member or the second member with the first side of the electrode stack supported by the first member and the second side of the electrode stack supported by the second member.

18. The method of claim 14, comprising:
securing, via a clamping mechanism, the first member with the second member, the clamping mechanism to apply the pressure to the electrode stack to maintain alignment of the solid-state electrolyte layer with the electrode layer.

19. A battery cell, comprising:
an aligned electrode stack made from an electrode stack comprising a solid-state electrolyte layer and an electrode layer, wherein
a first side of the electrode stack is supported by a first member of a holder;
a second member of the holder is provided on a second side of the electrode stack; and
a pressure is applied via at least one of the first member or the second member to the electrode stack to maintain alignment of the solid-state electrolyte layer and the electrode layer.

20. The battery cell of claim 19, comprising:
the first member defining a cavity, the first member to support the first side of the electrode stack with the electrode stack within the cavity, the first member including a thermally insulative material to retain heat within the cavity with the electrode stack within the cavity.
